(19) United States
(12) Patent Application Publication
(10) Pub. No.: US 2026/0188251 A1
(43) Pub. Date: Jul. 2, 2026

(54) DISPLAY DEVICE AND ELECTRONIC DEVICE INCLUDING THE SAME

(71) Applicant: Samsung Display Co., LTD., Yongin-si (KR)

(72) Inventors: YUNMI KIM, Yongin-si (KR); KYUNGHO KIM, Yongin-si (KR); DONG HEE SHIN, Yongin-si (KR); JUNGHWAN HWANG, Yongin-si (KR)

(21) Appl. No.: 19/386,609

(22) Filed: Nov. 12, 2025

(30) Foreign Application Priority Data
Dec. 31, 2024 (KR) 10-2024-0202493

(51) Int. Cl. G09G 3/3266; G09G 3/32; G09G 3/3291

(52) U.S. Cl. CPC G09G 3/3266; G09G 3/32; G09G 3/3291; G09G 2310/0267; G09G 2310/0275; G09G 2310/0286; G09G 2330/022

(57) ABSTRACT

A display device includes a display panel including a pixel and displaying an image in a first mode or a second mode, a source driver applying a data voltage to the pixel, and a scan driver including a plurality of stages and applying a scan signal to the pixel. Each stage receives k clock signals, the k is an integer greater than or equal to 2, the k clock signals are sequentially activated in the first mode to apply the scan signal to the pixel, at least two clock signals among the k clock signals are activated simultaneously in the second mode to apply the scan signal to the pixel, and at least one clock signal among the k clock signals is activated in different periods in a first frame and a second frame following the first frame in the second mode.

This application claims priority to Korean Patent Application No. 10-2024-0202493, filed on Dec. 31, 2024, and all the benefits accruing therefrom under 35 U.S.C. § 119, the content of which in its entirety is herein incorporated by reference.

### BACKGROUND

### 1. Field

The disclosure relates to a display device and an electronic device including the same. More particularly, the disclosure relates to a display device capable of operating at relatively high speed and with improved display quality.

### 2. Description of Related Art

In general, electronic devices, such as smartphones, digital cameras, notebook computers, navigation devices, and smart televisions, which provide images to users, include a display device to display the images. The display device generates the images and provides the generated images to the user through a display screen.

The display device includes a display panel displaying the images, a scan driver sequentially applying scan signals to scan lines included in the display panel, and a source driver applying data signals to data lines included in the display panel.

### SUMMARY

The disclosure provides a display device capable of operating at relatively high speed and with improved display quality and an electronic device including the display device.

An embodiment of the inventive concept provides a display device including a display panel including a pixel and displaying an image in a first mode or a second mode, a source driver applying a data voltage to the pixel, and a scan driver including a plurality of stages and applying a scan signal to the pixel. Each of the plurality of stages receives k clock signals, the k is an integer greater than or equal to 2, the k clock signals are sequentially activated in the first mode to apply the scan signal to the pixel, at least two clock signals among the k clock signals are activated simultaneously in the second mode to apply the scan signal to the pixel, and at least one clock signal among the k clock signals is activated in different periods in a first frame and a second frame following the first frame in the second mode.

In an embodiment, the k is greater than or equal to 4, the k clock signals are grouped into k/2 clock groups, and clock signals included in a same clock group among the k clock signals are activated simultaneously.

In an embodiment, at least one clock group among the k/2 clock groups includes p clock signals in the first frame, the at least one clock group includes q clock signals in the second frame, the q is an integer different from the p, and each of the p and the q is an integer smaller than the k.

In an embodiment, when a first clock signal among the p clock signals is activated, remaining p-1 clock signals are activated in synchronization with an activation time point of the first clock signal among the p clock signals in the first frame, and when a first clock signal among the q clock signals is activated, remaining q-1 clock signals are activated in synchronization with an activation time point of the first clock signal among the q clock signals in the second frame.

In an embodiment, each of the plurality of stages is connected to k scan lines, p scan signals, which are activated at an activation time point of the p clock signals, are output to p scan lines among the k scan lines, respectively, in the first frame, and q scan signals, which are activated at an activation time point of the q clock signals, are output to q scan lines among the k scan lines, respectively, in the second frame, Scan signals are activated simultaneously in response to clock signals activated simultaneously.

In an embodiment, the pixel is provided in plural, a first scan signal is applied to pixels arranged in a first pixel row, and a second scan signal is applied to pixels arranged in a second pixel row.

In an embodiment, a first row data voltage applied to the pixels arranged in the first pixel row are applied to the pixels arranged in the first and the second pixel row when the first and second scan signals are activated simultaneously.

In an embodiment, a second row data voltage applied to the pixels arranged in the second pixel row are applied to the pixels arranged in the first and the second pixel row when the first and second scan signals are activated simultaneously.

In an embodiment, the at least one clock group includes g clock signals in a third frame following the second frame, the g is an integer different from the p and the q, the at least one clock group includes h clock signals in a fourth frame following the third frame, h is an integer different from the p and the g, and each of the g and the h is an integer smaller than the k.

In an embodiment, the k is 6, and the clock group includes a first clock group, a second clock group, and a third clock group.

In an embodiment, each of the first clock group, the second clock group, and the third clock group includes two clock signals in the first frame, the first clock group includes three clock signals in the second frame, the second clock group includes one clock signal in the second frame, and the third clock group includes two clock signals in the second frame.

In an embodiment, each of the first clock group, the second clock group, and the third clock group includes two clock signals in the first frame, the first clock group includes two clock signals in the second frame, the second clock group includes three clock signals in the second frame, and the third clock group includes one clock signal in the second frame.

In an embodiment, each of the first clock group, the second clock group, and the third clock group includes two clock signals in the first frame, the first clock group includes one clock signal in the second frame, the second clock group includes two clock signals in the second frame, and the third clock group includes three clock signals in the second frame.

An embodiment of the inventive concept provides a display device including a display panel including pixels, data lines, and scan lines and displaying an image in a first mode or a second mode, a source driver applying a data voltage to the data lines, and a scan driver applying a scan signal to the scan lines. The scan signal is sequentially applied to the scan lines in the first mode, the scan signal is applied simultaneously to at least two scan lines among the scan lines in the second mode, a first row data voltage corresponding to the pixels connected to a first scan line of the at least two scan lines is applied to the data lines in a first frame, and a second row data voltage corresponding to the pixels connected to a second scan line of the at least two scan lines is applied to the data lines in a second frame following the first frame.

In an embodiment, the scan driver includes a plurality of stages, each of the plurality of stages receives k clock signals, the k is an integer greater than or equal to 2, the k clock signals are sequentially activated in the first mode, and at least two clock signals among the k clock signals are activated simultaneously in the second mode.

In an embodiment, the k is greater than or equal to 4, the k clock signals are grouped into k/2 clock groups, and clock signals included in a same clock group among the k clock signals are activated simultaneously.

In an embodiment, at least one clock group among the k/2 clock groups includes p clock signals in the first frame and the second frame, and the p is an integer smaller than the k.

In an embodiment, when a first clock signal among the p clock signals is activated, remaining p-1 clock signals are activated in synchronization with an activation time point of the first clock signal among the p clock signals in the first frame and the second frame.

In an embodiment, the display device further includes a first intermediate frame between the first frame and the second frame and a second intermediate frame following the second frame. The at least one clock group includes q clock signals in the first intermediate frame, the q is an integer different from the p, the at least one clock group includes h clock signals in the second intermediate frame, the h is an integer different from the q, and each of the q and the h is smaller than the k.

An embodiment of the inventive concept provides an electronic device including a display panel including a pixel and displaying an image in a first mode or a second mode, a source driver applying a data voltage to the pixel, a scan driver including a plurality of stages and applying a scan signal to the pixel, a driving controller receiving an image signal and a control signal and controlling a drive of the scan driver and the source driver, and a main processor applying the image signal and the control signal to the driving controller. Each of the plurality of stages receives k clock signals, the k is an integer greater than or equal to 2, the k clock signals are sequentially activated in the first mode to apply the scan signal to the pixel, at least two clock signals among the k clock signals are activated simultaneously in the second mode to apply the scan signal to the pixel, and at least one clock signal among the k clock signals is activated in different periods in a first frame and a second frame following the first frame in the second mode.

According to the above, the display panel selectively operates in the first mode or the second mode. In the first mode, the clock signals are sequentially activated, and in the second mode, some of the clock signals are simultaneously activated. Since a length of one frame is shortened in the second mode compared to that of the first mode, the display panel is driven at relatively high speed.

According to the above, since the clock signals activated simultaneously in the first frame are set different from the clock signals activated simultaneously in the second frame, differences arise between the image displayed in the first frame and the image displayed in the second frame. Thus, a user perceives an image in which the images displayed in the first and second frames are overlaid. As the overlaid image has an average grayscale value of the images in the first and second frames, the overlaid image is provided in a variety of grayscale tones compared to those actually displayed by the display panel. Thus, the display panel provides images with improved resolution to the user.

### BRIEF DESCRIPTION OF THE DRAWINGS

The above and other embodiments, advantages and features of this disclosure will become more apparent by describing in further detail embodiments thereof with reference to the accompanying drawings, in which:

FIG. 1 is a perspective view showing an embodiment of a display device according to the disclosure;

FIG. 2 is a plan view showing an embodiment of a display device according to the disclosure;

FIG. 3A is a block diagram showing a display device according to the disclosure;

FIG. 3B is a block diagram showing a driving controller and a source driver shown in FIG. 3A;

FIG. 4 is a circuit diagram showing an embodiment of a pixel according to the disclosure;

FIG. 5A is a block diagram showing an embodiment of some components of a display panel according to the disclosure;

FIG. 5B is a block diagram showing an embodiment of some components of a display panel according to the disclosure;

FIG. 6A is a view showing an embodiment of a scan driver according to the disclosure;

FIG. 6B is an equivalent circuit diagram showing an embodiment of one stage according to the disclosure;

FIG. 7A is a timing diagram showing an embodiment of an operation of a display panel in a first mode according to the disclosure;

FIG. 7B is a view showing an image displayed on the display panel according to the timing diagram of FIG. 7A;

FIG. 8A is a timing diagram showing an embodiment of an operation of a display panel in a second mode according to the disclosure;

FIGS. 8B to 8D are views showing images displayed on the display panel according to the timing diagram of FIG. 8A;

FIG. 9A is a timing diagram showing an embodiment of an operation of a display panel in a second mode according to the disclosure;

FIGS. 9B and 9C are views showing images displayed on the display panel according to the timing diagram of FIG. 9A;

FIG. 10A is a timing diagram showing an embodiment of an operation of a display panel in a second mode according to the disclosure;

FIGS. 10B and 10C are views showing images displayed on the display panel according to the timing diagram of FIG. 10A;

FIG. 11A is a timing diagram showing an embodiment of an operation of a display panel in a second mode according to the disclosure;

FIG. 11B is a view showing an image displayed on the display panel according to the timing diagram of FIG. 11A;

FIG. 12A is a timing diagram showing an embodiment of an operation of a display panel in a second mode according to the disclosure;

FIGS. 12B and 12C are views showing images displayed on the display panel according to the timing diagram of FIG. 12A;

FIG. 13A is a timing diagram showing an embodiment of an operation of a display panel in a second mode according to the disclosure;

FIG. 13B is a view showing an image displayed on the display panel according to the timing diagram of FIG. 13A;

FIG. 14A is a timing diagram showing an embodiment of an operation of a display panel in a second mode according to the disclosure;

FIGS. 14B and 14C are views showing images displayed on the display panel according to the timing diagram of FIG. 14A; and

FIG. 15 is a block diagram showing an embodiment of an electronic device according to the disclosure.

### DETAILED DESCRIPTION

In the disclosure, it will be understood that when an element (or area, layer, or portion) is referred to as being “on”, “connected to” or “coupled to” another element or layer, it may be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” or the like, may be used herein for ease of description to describe one element or feature's relationship to another elements or features as shown in the drawing figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the disclosure will be described with reference to accompanying drawings.

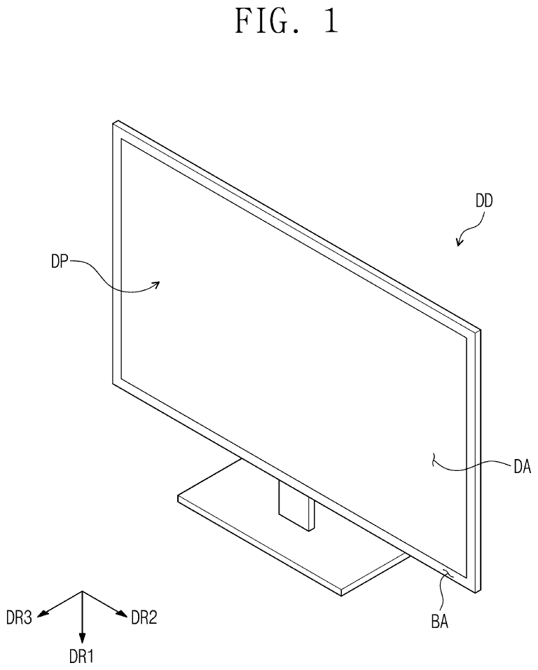

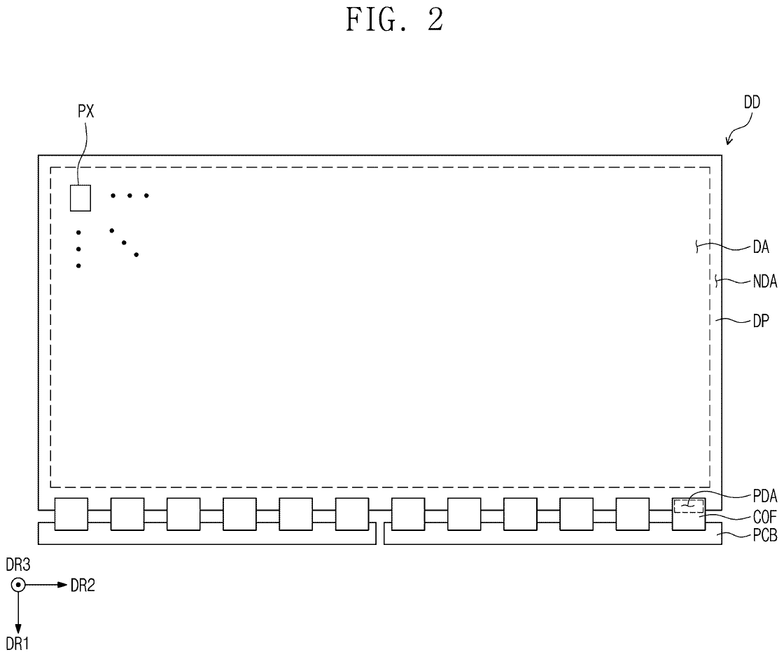

FIG. 1 is a perspective view showing an embodiment of a display device according to the disclosure. FIG. 2 is a plan view showing an embodiment of a display device according to the disclosure.

Referring to FIGS. 1 and 2, the display device DD may be activated in response to electrical signals. The display device DD may be applied to a large-sized electronic device, such as a television set, a monitor, an outdoor billboard, etc., and a small and medium-sized electronic device, such as a personal computer, a notebook computer, a personal digital terminal, a car navigation unit, a game unit, a mobile electronic device, a camera, etc. However, these are merely illustrative embodiments, and the display device DD may be applied to other electronic devices as long as they do not depart from the concept of the disclosure. The display device DD shown in FIG. 1 may be the monitor.

The display device DD may include a display panel DP, a connection film COF, and a circuit board PCB.

The display panel DP may have a configuration that substantially generates images. The display panel DP may be a light-emitting type display panel, and in an embodiment, the display panel DP may be an organic light-emitting display panel, an inorganic light-emitting display panel, an organic-inorganic light-emitting display panel, a quantum dot display panel, a micro-light-emitting diode (“LED”) display panel, or a nano-LED display panel, however, the disclosure should not be particularly limited. The display panel DP may be small or medium-sized, measuring a few inches to a dozen inches or less. In an embodiment, the display panel DP may be large-sized, measuring tens of inches or more.

The display panel DP may include a display area DA and a non-display area NDA. The display panel DP may display images through the display area DA. In an embodiment, the display panel DP may include a plurality of pixels PX, and the pixels PX may be arranged in the display area DA. The display area DA may include a plane defined by a first direction DR1 and a second direction DR2. The display area DA may display the images through a third direction DR3 intersecting the first direction DR1 and the second direction DR2. The non-display area NDA may surround the display area DA.

A bezel area BA of the display device DD may cover at least a portion of the non-display area of the display panel DP. The bezel area BA may cover the entirety of the non-display area NDA or may cover a portion of the non-display area NDA. When a size of the non-display area is reduced, a size of the bezel area BA may also be reduced.

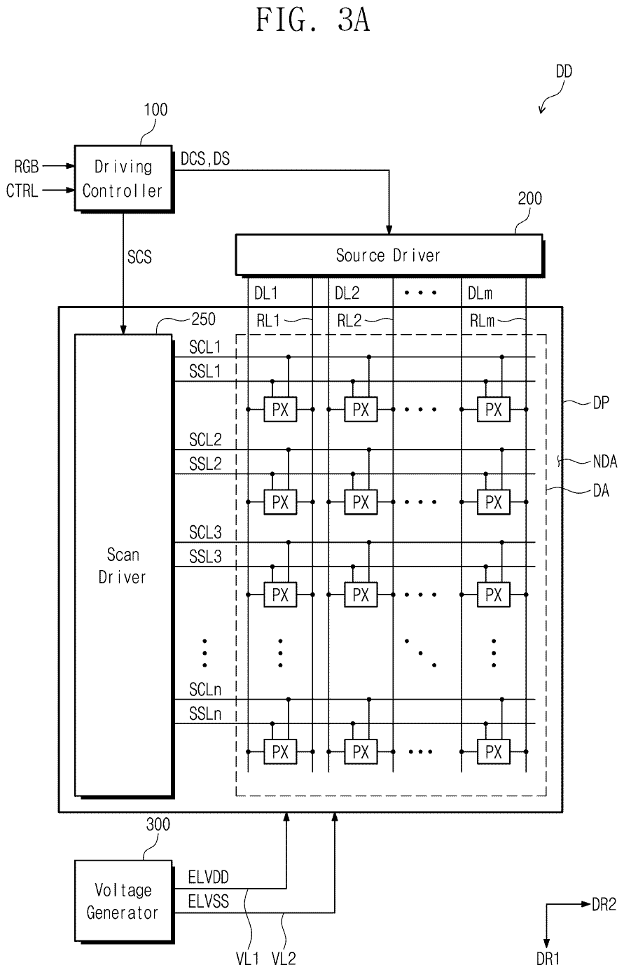

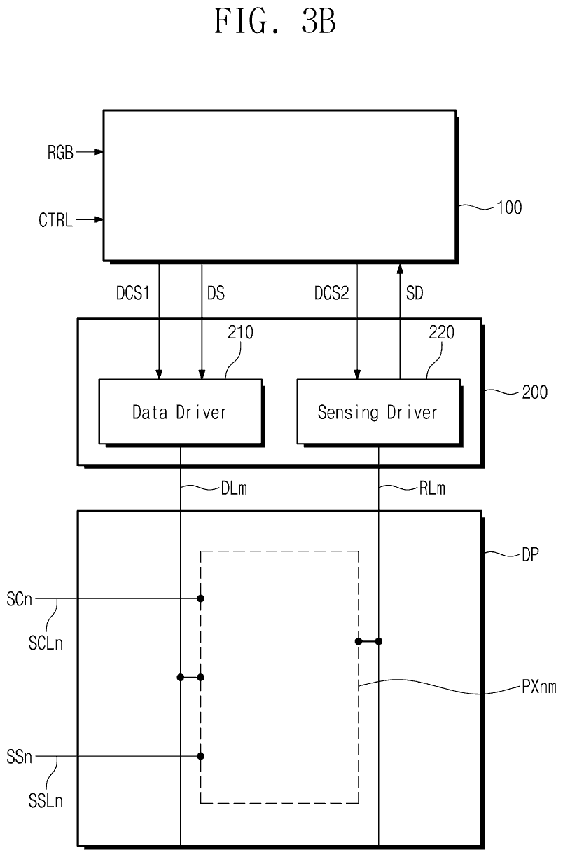

The connection film COF may be provided in plural. A driving circuit, e.g., a source driver 200 (refer to FIG. 3A), may be disposed (e.g., mounted) on each of the connection films COF to drive the display panel DP. The connection films COF may be coupled to the non-display area NDA of the display panel DP. In an embodiment, the connection films COF may be attached to one side of the display panel DP. The connection films COF may be coupled to a pad area PDA of the display panel DP. The pad area PDA may be defined in the non-display area NDA of the display panel DP. The connection films COF may be coupled with the display panel DP by an anisotropic conductive film (“ACF”), however, the disclosure should not be limited thereto or thereby.

The circuit board PCB may be provided in plural. Each of the circuit boards PCB may be electrically connected to the display panel DP through corresponding connection films among the connection films COF. A chip, e.g., a driving controller 100 (refer to FIG. 3A), may be disposed (e.g., mounted) on the circuit board PCB to control an operation of the display panel DP.

FIG. 2 shows twelve connection films COF, however, the disclosure should not be limited thereto or thereby. FIG. 2 shows two circuit boards PCB, however, the disclosure should not be limited thereto or thereby. In an embodiment, the number of the connection films COF and the number of the circuit boards PCB may vary depending on a resolution of the display panel DP, a size of the display panel DP, specifications of a data driving circuit, etc., for example.

FIG. 3A is a block diagram showing an embodiment of the display device according to the disclosure. FIG. 3B is a block diagram showing the driving controller and the source driver shown in FIG. 3A.

Referring to FIGS. 3A and 3B, the display device DD may include the driving controller 100, the source driver 200, a scan driver 250, a voltage generator 300, and the display panel DP. In an embodiment, the source driver 200 may include a data driver 210 and a sensing driver 220.

The display panel DP may include driving scan lines SCL1 to SCLn, sensing scan lines SSL1 to SSLn, data lines DL1 to DLm, sensing lines RL1 to RLm, and the pixels PX. Here, n and m are natural numbers. The display panel DP may include the display area DA and the non-display area NDA. The pixels PX may be arranged in the display area DA, and the scan driver 250 may be disposed in the non-display area NDA.

The driving scan lines SCL1 to SCLn and the sensing scan lines SSL1 to SSLn may extend parallel to the second direction DR2 and may be spaced apart from each other in the first direction DR1. The second direction DR2 may intersect the first direction DR1. The data lines DL1 to DLm may extend parallel to the first direction DR1 from the source driver 200 and may be spaced apart from each other in the second direction DR2. The sensing lines RL1 to RLm may extend parallel to the first direction DR1 and may be spaced apart from each other in the second direction DR2.

The pixels PX may be electrically connected to the driving scan lines SCL1 to SCLn, the sensing scan lines SSL1 to SSLn, the data lines DL1 to DLm, and the sensing lines RL1 to RLm, respectively. Each of the pixels PX may be electrically connected to two scan lines. In an embodiment, as shown in FIG. 3B, a pixel PXnm may be connected to an n-th driving scan line SCLn, an n-th sensing scan line SSLn, an m-th data line DLm, and an m-th sensing line RLm. However, the number of the scan lines connected to each pixel PX should not be limited to two. In an embodiment, each pixel PX may be electrically connected to one or three scan lines.

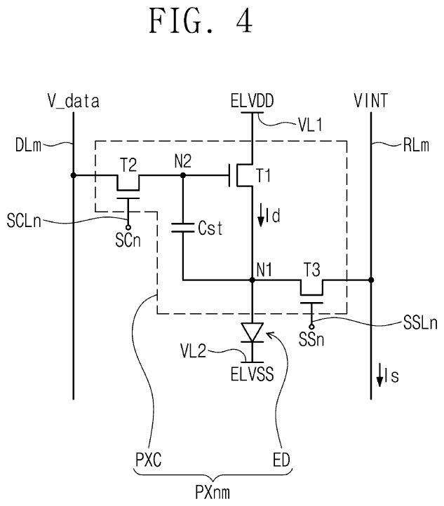

Each of the pixels PX may include a light-emitting element ED (refer to FIG. 4) and a pixel circuit part PXC (refer to FIG. 4) that controls an emission of the light-emitting element ED. The pixel circuit part PXC may include a plurality of transistors and a capacitor.

The driving controller 100 may receive an input image signal RGB and a control signal CTRL from a main controller, e.g., a microcontroller or a graphics controller. The driving controller 100 may convert the input image signal RGB to generate image data DS.

The driving controller 100 may generate a scan control signal SCS and a source control signal DCS in response to the control signal CTRL. The source control signal DCS may include a data control signal DCS1 to control a drive of the data driver 210 and a sensing control signal DCS2 to control a drive of the sensing driver 220.

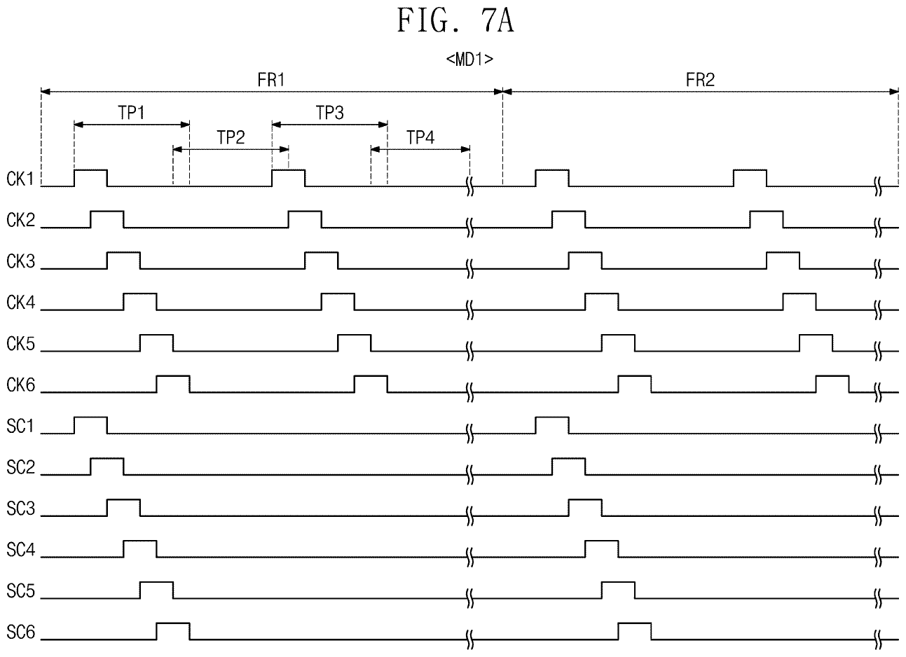

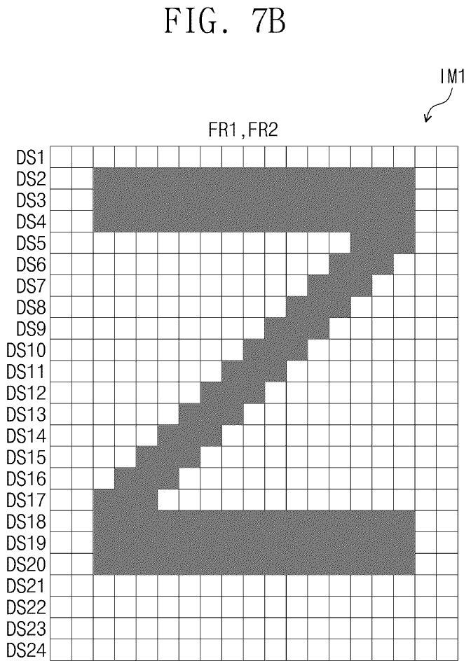

The data driver 210 may receive the data control signal DCS1 and the image data DS from the driving controller 100 and may convert the image data DS into data voltages. The data driver 210 may output the data voltages DS1 to DS24 (refer to FIG. 7B) to the data lines DL1 to DLm. The data voltages may be analog voltages corresponding to grayscale values of the image data DS displayed on the display panel DP.

The sensing driver 220 may receive the sensing control signal DCS2 from the driving controller 100. The sensing driver 220 may sense the display panel DP in response to the sensing control signal DCS2. The sensing driver 220 may sense characteristics of elements included in each pixel PX of the display panel DP through the sensing lines RL1 to RLm.

In an embodiment, the source driver 200 may be implemented in at least one chip. In an embodiment, when the source driver 200 is implemented in a single chip, the data driver 210 and the sensing driver 220 may be built-in in the chip. In addition, when the source driver 200 is implemented in multiple chips, the data driver 210 and the sensing driver 220 may be built-in in each of the chips.

In the illustrated embodiment, a structure in which the data driver 210 and the sensing driver 220 are built-in in the source driver 200 is shown as an illustrative embodiment, however, the disclosure should not be limited thereto or thereby. In an embodiment, the data driver 210 and the sensing driver 220 may be implemented in separate chips. In this case, the data driver 210 may be placed or disposed (e.g., mounted) on the connection film COF shown in FIG. 2.

The driving controller 100 may drive the sensing driver 220 during a power-on period, i.e., a period when power starts to be applied to the display device DD, or during a power-off period, i.e., a period when the application of the power to the display device DD is terminated. In an alternative embodiment, the driving controller 100 may drive the sensing driver 220 during a predetermined period where essentially no image is displayed, e.g., during a blank period, within an operation period where the display device DD displays the image.

Elements such as the light-emitting element ED and the transistors included in the pixels PX may deteriorate in proportion to their operating time, which may lead to degradation of predetermined characteristics, such as a threshold voltage. To compensate for the degradation in the characteristics, the sensing driver 220 may sense characteristics of elements in at least one pixel among the pixels PX and may feedback sensed sensing data SD to the driving controller 100. The driving controller 100 may compensate for the input image signal RGB based on the sensing data SD fed back from the sensing driver 220.

The scan driver 250 may receive the scan control signal SCS from the driving controller 100. The scan driver 250 may output scan signals in response to the scan control signal SCS. The scan driver 250 may be implemented in the form of a chip and may be disposed (e.g., mounted) on the display panel DP. In an alternative embodiment, the scan driver 250 may be built-in in the display panel DP. When the scan driver 250 is built-in in the display panel DP, the scan driver 250 may include transistors formed through the same process as the pixel circuit part PXC.

The scan driver 250 may generate a plurality of driving scan signals and a plurality of sensing scan signals in response to the scan control signal SCS. The driving scan signals may be applied to the driving scan lines SCL1 to SCLn, and the sensing scan signals may be applied to the sensing scan lines SSL1 to SSLn.

Each of the pixels PX may receive a first driving voltage ELVDD and a second driving voltage ELVSS.

The voltage generator 300 may generate voltages desired for the operation of the display panel DP. The voltage generator 300 may generate the first driving voltage ELVDD and the second driving voltage ELVSS, which are desired for the operation of the display panel DP. The first driving voltage ELVDD and the second driving voltage ELVSS may be applied to the display panel DP through a first driving voltage line VL1 and a second driving voltage line VL2.

The voltage generator 300 may further generate various voltages, such as, a gamma reference voltage, a data driving voltage, a gate-on volage, a gate-off voltage, etc., which are desired for the operations of the source driver 200 and the scan driver 250, in addition to the first driving voltage ELVDD and the second driving voltage ELVSS.

FIG. 4 is a circuit diagram showing an embodiment of the pixel according to the disclosure.

FIG. 4 shows an equivalent circuit diagram of the pixel PXnm shown in FIG. 3B as an illustrative embodiment. Since the pixels PX (refer to FIG. 3A) have substantially the same circuit configuration, the circuit configuration of the pixel PXnm will be described in detail, and details of other pixels will be omitted.

Referring to FIG. 4, the pixel PXnm may be connected to the m-th data line DLm, the n-th driving scan line SCLn, the n-th sensing scan line SSLn, and the m-th sensing line RLm.

The pixel PXnm may include the light-emitting element ED and the pixel circuit part PXC. The light-emitting element ED may be a light-emitting diode. In an embodiment, the light-emitting element ED may be an organic light-emitting diode including an organic light-emitting layer. The light-emitting element ED may be one of a red light-emitting diode emitting a red light, a green light-emitting diode emitting a green light, and a blue light-emitting diode emitting a blue light.

The pixel circuit part PXC may include first, second, and third transistors T1, T2, and T3 and a capacitor Cst. At least one of the first, second, and third transistors T1, T2, and T3 may include a low-temperature polycrystalline silicon (“LTPS”) semiconductor layer. Each of the first, second, and third transistors T1, T2, and T3 may be an N-type transistor, however, the disclosure should not be limited thereto or thereby. Each of the first, second, and third transistors T1, T2, and T3 may be a P-type transistor. In an alternative embodiment, one of more transistors of the first, second, and third transistors T1, T2, and T3 may be N-type transistors, and remaining (the other) transistors may be P-type transistors. In addition, at least one of the first, second, and third transistors T1, T2, and T3 may include an oxide semiconductor layer.

The circuit configuration of the pixel circuit part PXC according to the disclosure should not be limited to the circuit configuration shown in FIG. 4. The pixel circuit part PXC shown in FIG. 4 is merely one of embodiments, and the circuit configuration of the pixel circuit part PXC may vary. In an embodiment, the third transistor T3 may be omitted from the pixel circuit part PXC.

The first transistor T1 may be connected between the first driving voltage line VL1 receiving the first driving voltage ELVDD and the light-emitting element ED. The first transistor T1 may include a first electrode connected to the first driving voltage line VL1, a second electrode connected to an anode of the light-emitting element ED, and a third electrode connected to one end of the capacitor Cst. In the illustrated embodiment, a point where the anode of the light-emitting element ED and the second electrode of the first transistor T1 are connected may be also referred to as a first node N1. In the disclosure, the expression “a transistor is connected to a signal line” means that one of a first electrode, a second electrode, and a third electrode of the transistor is integrally formed (or unitary) with the signal line or is connected to the signal line via a connecting electrode. In addition, the expression “a transistor is electrically connected to another transistor” means that one of a first electrode, a second electrode, and a third electrode of the transistor has an integral shape with one of first, second, and third electrodes of another transistor or is connected to one of the first, second, and third electrodes of another transistor via a connecting electrode.

The first transistor T1 may receive a data voltage V_data transmitted through the m-th data line DLm according to a switching operation of the second transistor T2 and may supply a driving current Id to the light-emitting element ED.

The second transistor T2 may be connected between the m-th data line DLm and the third electrode of the first transistor T1. The second transistor T2 may include a first electrode connected to the m-th data line DLm, a second electrode connected to the third electrode of the first transistor T1, and a third electrode connected to the n-th driving scan line SCLn. In the disclosure, a point where the second electrode of the second transistor T2 is connected to the third electrode of the first transistor T1 may be also referred to as a second node N2. The second transistor T2 may be turned on in response to an n-th driving scan signal SCn received through the n-th driving scan line SCLn and may transmit the data voltage V_data received through the m-th data line DLm to the third electrode of the first transistor T1.

The third transistor T3 may be connected between the second electrode of the first transistor T1 and the m-th sensing line RLm. The third transistor T3 may include a first electrode connected to the first node N1, a second electrode connected to the m-th sensing line RLm, and a third electrode connected to the n-th sensing scan line SSLn. The third transistor T3 may be turned on in response to an n-th sensing scan signal SSn received through the n-th sensing scan line SSLn and may electrically connect the m-th sensing line RLm and the first node N1.

The one end of the capacitor Cst may be connected to the second node N2, and an opposite end of the capacitor Cst may be connected to the first node N1. A cathode of the light-emitting element ED may be connected to the second driving voltage line VL2 that transmits the second driving voltage ELVSS. The second driving voltage ELVSS may have a level lower than that of the first driving voltage ELVDD.

The light-emitting element ED may include the anode connected to the second electrode (or the first node N1) of the first transistor T1 and the cathode receiving the second driving voltage ELVSS. The light-emitting element ED may generate a light corresponding to an amount of current provided from the first transistor T1.

When the image is displayed, the third transistor T3 may transmit an initialization voltage VINT to the first node N1 in response to the n-th sensing scan signal SSn. That is, when the third transistor T3 is turned on, the second electrode of the first transistor T1 may be reset to the initialization voltage VINT.

During the sensing operation, the third transistor T3 may supply a sensing current Is corresponding to a voltage at the first node N1 to the m-th sensing line RLm in response to the n-th sensing scan signal SSn. The sensing driver 220 (refer to FIG. 3B) may receive the sensing current Is through the m-th sensing line RLm, may convert the sensing current Is into the sensing data SD (refer to FIG. 3B), and may provide the sensing data SD (refer to FIG. 3B) to the driving controller 100 (refer to FIG. 3B).

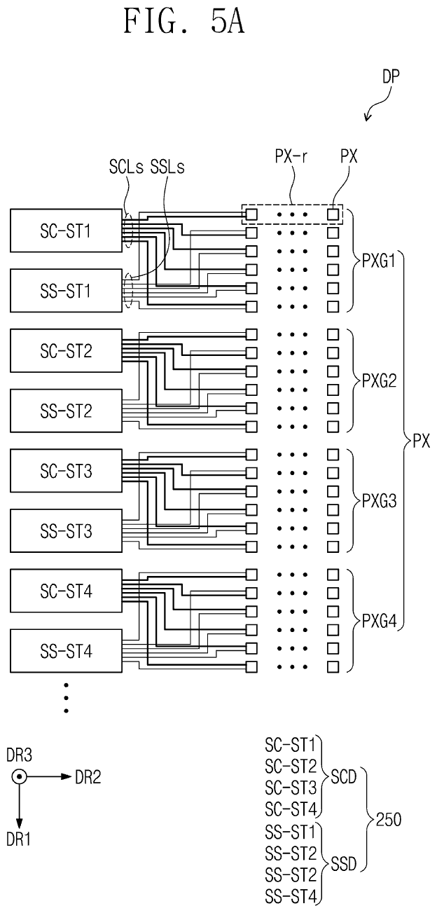

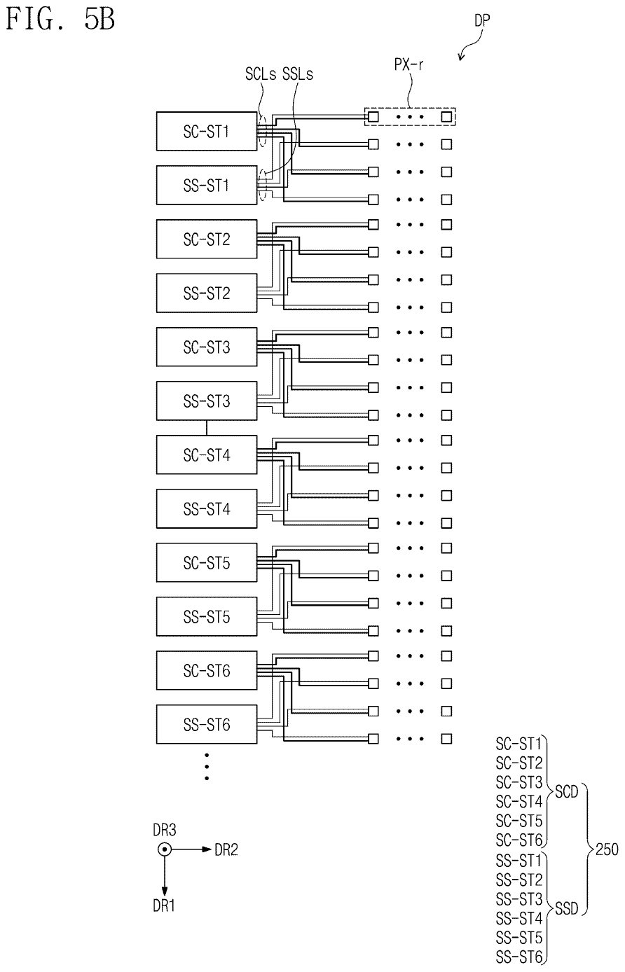

FIG. 5A is a block diagram showing an embodiment of some components of the display panel according to the disclosure. FIG. 5B is a block diagram showing an embodiment of some components of a display panel according to the disclosure.

Referring to FIG. 5A, a portion of the scan driver 250 and the pixels PX are shown. The scan driver 250 may include a driving scan circuit SCD and a sensing scan circuit SSD. The driving scan circuit SCD may include a plurality of driving stages SC-ST1, SC-ST2, SC-ST3, and SC-ST4, and the sensing scan circuit SSD may include a plurality of sensing stages SS-ST1, SS-ST2, SS-ST3, and SS-ST4.

The driving stages SC-ST1, SC-ST2, SC-ST3, and SC-ST4 may be arranged in the first direction DR1, and the sensing stages SS-ST1, SS-ST2, SS-ST3, and SS-ST4 may be arranged in the first direction DR1. In addition, the driving stages SC-ST1, SC-ST2, SC-ST3, and SC-ST4 and the sensing stages SS-ST1, SS-ST2, SS-ST3, and SS-ST4 may be alternately arranged one by one along the first direction DR1.

Each of the driving stages SC-ST1, SC-ST2, SC-ST3, and SC-ST4 may be electrically connected to the driving scan lines SCLs. In addition, each of the sensing stages SS-ST1, SS-ST2, SS-ST3, and SS-ST4 may be electrically connected to the sensing scan lines SSLs. In an embodiment, a first driving stage SC-ST1 may be connected to k driving scan lines SCLs to output k driving scan signals, and a first sensing stage SS-ST1 may be connected to k sensing scan lines SSLs to output k sensing scan signals. In the illustrated embodiment, k is an integer greater than or equal to 2.

FIG. 5A shows a structure in which the first driving stage SC-ST1 is electrically connected to six driving scan lines SCLs and the first sensing stage SS-ST1 is electrically connected to six sensing scan lines SSLs as an illustrative embodiment, however, the disclosure should not be particularly limited. In an embodiment, the first driving stage SC-ST1 may be electrically connected to four driving scan lines SCLs and the first sensing stage SS-ST1 may be electrically connected to four sensing scan lines SSLs as shown in FIG. 5B.

In an embodiment, the pixels PX may be arranged in the first direction DR1 and the second direction DR2. Among the pixels PX, pixels arranged in one row along the second direction DR2 may be also referred to as a pixel row PX-r. In addition, the pixels PX may include pixels PXG1 (hereinafter, also referred to as first pixel groups) of k pixel rows arranged in the first direction DR1, and the first pixel groups PXG1 may be connected to the first driving stage SC-ST1 and the first sensing stage SS-ST1.

The first pixel groups PXG1 including first to sixth pixel rows PX-r may be connected to the first driving stage SC-ST1 and the first sensing stage SS-ST1. Second pixel groups PXG2 including seventh to twelfth pixel rows PX-r may be connected to a second driving stage SC-ST2 and a second sensing stage SS-ST2. Third pixel groups PXG3 including thirteenth to eighteenth pixel rows PX-r may be connected to a third driving stage SC-ST3 and a third sensing stage SS-ST3. Fourth pixel groups PXG4 including nineteenth to twenty-fourth pixel rows PX-r may be connected to a fourth driving stage SC-ST4 and a fourth sensing stage SS-ST4.

In an embodiment, one stage, e.g., the first driving stage SC-ST1, may control an operation of a pixel group, e.g., the first pixel group PXG1, including two or more pixel rows PX-r. That is, the number of the driving stages or the number of the sensing stages may be smaller than the number of rows of the pixels PX. Accordingly, the number of transistors, the number of capacitors, and the number of lines, e.g., the number of clock lines, which are arranged in the non-display area NDA (refer to FIG. 3A) to form the driving stages and the sensing stages, may be reduced. As a result, a width of the non-display area NDA (refer to FIG. 3A) of the display panel DP (refer to FIG. 3A) may decrease.

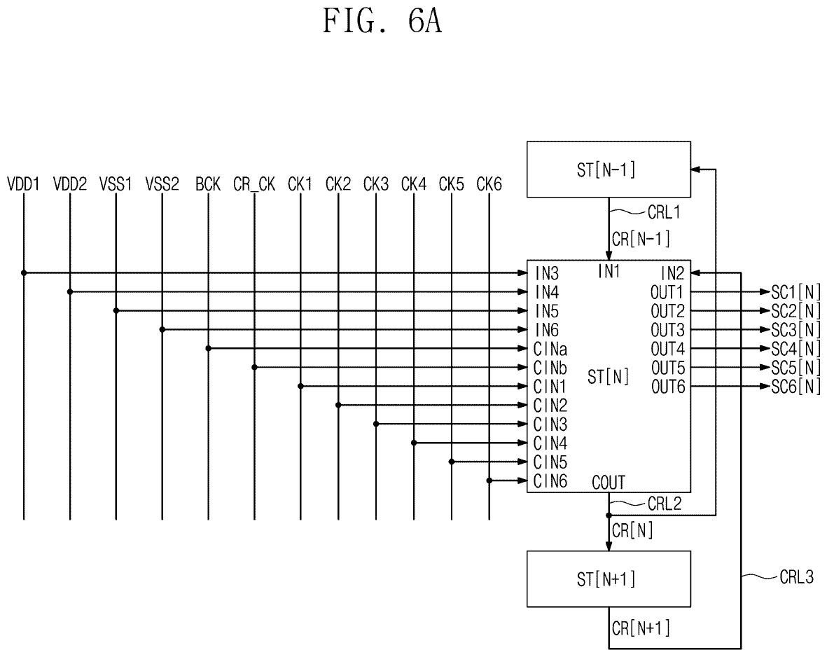

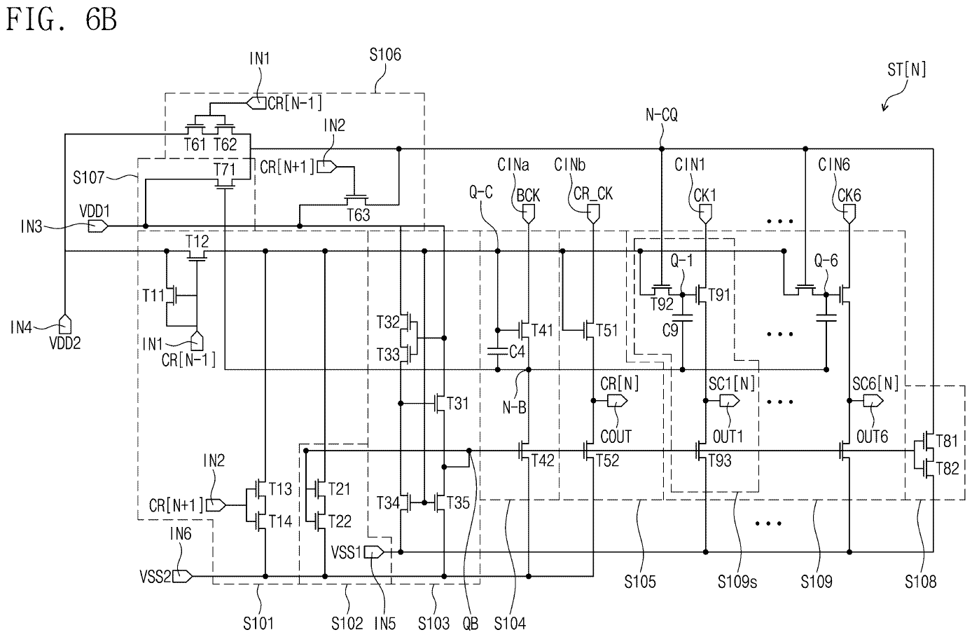

FIG. 6A is a view showing an embodiment of the scan driver according to the disclosure. FIG. 6B is an equivalent circuit diagram showing an embodiment of one stage according to the disclosure.

FIG. 6A shows three stages ST[N−1], ST[N], and ST[N+1] as an illustrative embodiment. In the illustrated embodiment, N is an integer greater than or equal to 2. Each of the three stages ST[N−1], ST[N], and ST[N+1] may correspond to one of the driving stages SC-ST1, SC-ST2, SC-ST3, and SC-ST4 (refer to FIG. 5A) or one of the sensing stages SS-ST1, SS-ST2, SS-ST3, and SS-ST4 (refer to FIG. 5A).

FIG. 6B shows an equivalent circuit diagram of one stage ST[N] as an illustrative embodiment. Since remaining (the other) stages ST[N−1] and ST[N+1] have substantially the same circuit configuration as the one stage ST[N], details of remaining (the other) stages ST[N−1] and ST[N+1] will be omitted. The circuit configuration of the one stage ST[N] should not be limited to the circuit configuration shown in FIG. 6B. The one stage ST[N] shown in FIG. 6B is merely one of embodiments, and the circuit configuration of the one stage ST[N] may be modified in various ways.

Referring to FIG. 6A, the stages ST[N−1], ST[N], and ST[N+1] may be also referred to as an (N−1)th stage ST[N−1], an N-th stage ST[N], and (N+1)th stage ST[N+1], respectively. In an embodiment, the N-th stage ST[N] may be also referred to as a reference stage or a current stage, the (N−1)th stage ST[N−1] may be also referred to as a first peripheral stage or a previous stage, and the (N+1)th stage ST[N+1] may be also referred to as a second peripheral stage or a next stage.

The N-th stage ST[N] may include first, second, third, fourth, fifth, and sixth input terminals IN1, IN2, IN3, IN4, IN5, and IN6, first, second, third, fourth, fifth, and sixth clock terminals CIN1, CIN2, CIN3, CIN4, CIN5, and CIN6, a first control terminal CINa, a second control terminal CINb, first, second, third, fourth, fifth and sixth output terminals OUT1, OUT2, OUT3, OUT4, OUT5, and OUT6, and a carry output terminal COUT.

The first input terminal IN1 of the N-th stage ST[N] may receive a carry signal CR[N−1] output from the previous stage, e.g., the (N−1)th stage ST[N−1]. The carry signal CR[N−1] may be also referred to as a previous carry signal or a first carry signal, and hereinafter, the carry signal CR[N−1] will be also referred to as the first carry signal CR[N−1]. In a case where the N-th stage ST[N] corresponds to a first stage, the first input terminal IN1 may receive a previous carry signal output from a dummy stage prior to the first stage or a start signal provided from the driving controller 100.

The (N−1)th stage ST[N−1] and the N-th stage ST[N] may be electrically connected to a first carry line CRL1, and the first carry line CRL1 may be also referred to as a first peripheral carry line. The first carry signal CR[N−1] generated by the (N−1)th stage ST[N−1] may be transmitted to the N-th stage ST[N] via the first carry line CRL1.

The second input terminal IN2 of the N-th stage ST[N] may receive a carry signal CR[N+1] output from the next stage, e.g., the (N+1)th stage ST[N+1]. The carry signal CR[N+1] may be also referred to as a next carry signal or a third carry signal, and hereinafter, the carry signal CR[N+1] may be also referred to as the third carry signal CR[N+1]. In a case where the N-th stage ST[N] corresponds to a last stage, the (N+1)th stage ST[N+1] may be a dummy stage to apply a next carry signal to the second input terminal IN2 of the N-th stage ST[N].

The (N+1)th stage ST[N+1] and the N-th stage ST[N] may be electrically connected to a third carry line CRL3, and the third carry line CRL3 may be also referred to as a second peripheral carry line. The third carry signal CR[N+1] generated by the (N+1)th stage ST[N+1] may be transmitted to the N-th stage ST[N] via the third carry line CRL3.

The third input terminal IN3 of the N-th stage ST[N] may receive a first high voltage VDD1, and the fourth input terminal IN4 of the N-th stage ST[N] may receive a second high voltage VDD2. The second high voltage VDD2 may have a voltage level higher than a voltage level of the first high voltage VDD1, however, the disclosure should not be limited thereto or thereby. In an embodiment, the first high voltage VDD1 may be about 15 volts (V), and the second high voltage VDD2 may be about 25 V.

The fifth input terminal IN5 of the N-th stage ST[N] may receive a first low voltage VSS1, and the sixth input terminal IN6 of the N-th stage ST[N] may receive a second low voltage VSS2. The first low voltage VSS1 may have the same voltage level as the second low voltage VSS2 or may have a different voltage level from the second low voltage VSS2. In an embodiment, a voltage level of the first low voltage VSS1 and a voltage level of the second low voltage VSS2 may be less than the voltage level of the first high voltage VDD1 and t the voltage level of the second high voltage VDD2, respectively, however, the disclosure should not be limited thereto or thereby.

The N-th stage ST[N] may receive a boost clock signal BCK through the first control terminal CINa and may receive a carry clock signal CR_CK through the second control terminal CINb. The N-th stage ST[N] may receive k clock signals from the k driving scan lines SCLs (refer to FIG. 5A) or the k sensing scan lines SSLs (refer to FIG. 5A). In an embodiment, the N-th stage ST[N] may receive first, second, third, fourth, fifth, and sixth clock signals CK1, CK2, CK3, CK4, CK5, and CK6 through the first, second, third, fourth, fifth, and sixth clock terminals CIN1, CIN2, CIN3, CIN4, CIN5, and CIN6. In addition, the first, second, third, fourth, fifth, and sixth clock terminals CIN1, CIN2, CIN3, CIN4, CIN5, and CIN6 of each of the (N−1)th stage ST[N−1] and the (N+1)th stage ST[N+1] may receive clock signals having inverted phases with respect to the first, second, third, fourth, fifth, and sixth clock signals CK1, CK2, CK3, CK4, CK5, and CK6.

The carry output terminal COUT of the N-th stage ST[N] may output a carry signal CR[N]. The carry signal CR[N] may be applied to the (N−1)th stage ST[N−1] and the (N+1)th stage ST[N+1]. The carry signal CR[N] may be also referred to as a current carry signal or a second carry signal, and hereinafter, the carry signal CR[N] may be also referred to as a second carry signal CR[N]. The (N−1)th stage ST[N−1], the N-th stage ST[N], and the (N+1)th stage ST[N+1] may be electrically connected to a second carry line CRL2. The second carry signal CR[N] generated by the N-th stage ST[N] may be applied to the (N−1)th stage ST[N−1] and the (N+1)th stage ST[N+1] through the second carry line CRL2.

The first, second, third, fourth, fifth and sixth output terminals OUT1, OUT2, OUT3, OUT4, OUT5, and OUT6 of the N-th stage ST[N] may output first, second, third, fourth, fifth, and sixth scan signals SC1[N], SC2[N], SC3[N], SC4[N], SC5[N], and SC6[N], respectively. The first, second, third, fourth, fifth, and sixth scan signals SC1[N], SC2[N], SC3[N], SC4[N], SC5[N], and SC6[N] may be respectively applied to the pixels arranged in six rows of the first pixel group PXG1.

The first, second, third, fourth, fifth, and sixth scan signals SC1[N], SC2[N], SC3[N], SC4[N], SC5[N], and SC6[N] may be the driving scan signals provided through the driving scan lines SCLs (refer to FIG. 5A), respectively. In an embodiment, the first, second, third, fourth, fifth, and sixth scan signals SC1[N], SC2[N], SC3[N], SC4[N], SC5[N], and SC6[N] may be the sensing scan signals provided through the sensing scan lines SSLs (refer to FIG. 5A), respectively.

Referring to FIG. 6B, the N-th stage ST[N] may include a first node Q-C, a second node QB, a third node N-CQ, a fourth node N-B, and a plurality of branch nodes Q-1 to Q-6. The first node Q-C may be also referred to as a Q node, the branch nodes Q-1 to Q-6 may be also referred to as branch Q nodes, and the second node QB may be also referred to as a QB node.

In addition, the N-th stage ST[N] may further include a first circuit S101, a second circuit S102, a third circuit S103, a fourth circuit S104, a fifth circuit S105, a sixth circuit S106, a seventh circuit S107, an eighth circuit S108, and a ninth circuit S109.

The first circuit S101 may control a voltage at the first node Q-C and may be also referred to as a first node control circuit. The first circuit S101 may include first-first, first-second, first-third, and first-fourth transistors T11, T12, T13, and T14.

The first-first transistor T11 and the first-second transistor T12 may be connected to each other in series, and the first-first and first-second transistors T11 and T12 may have a dual-gate structure. The first-first transistor T11 and the first-second transistor T12 may be connected between the first input terminal IN1 and the first node Q-C. In addition, a gate electrode of the first-first transistor T11 and a gate electrode of the first-second transistor T12 may be connected to the first input terminal IN1. The fourth input terminal IN4 may be connected between the first-first transistor T11 and the first-second transistor T12. The first-first and first-second transistors T11 and T12 may be turned on in response to a gate on-voltage, e.g., a logic high level, of the first carry signal CR[N−1], and the first-second transistor T12 may apply the second high voltage VDD2 to the first node Q-C. The operation of applying the second high voltage VDD2 to the first node Q-C may be also referred to as a pre-charging operation or a first boosting operation. The first-third transistor T13 and the first-fourth transistor T14 may be connected to each other in series, and the first-third and first-fourth transistors T13 and T14 may have a dual-gate structure. The first-third and first-fourth transistors T13 and T14 may be connected between the first node Q-C and the sixth input terminal IN6. In addition, a gate electrode of the first-third transistor T13 and a gate electrode of the first-fourth transistor T14 may be connected to the second input terminal IN2. The first-third and first-fourth transistors T13 and T14 may be turned on in response to a gate on-voltage, e.g., a logic high level, of the third carry signal CR[N+1], and may apply the second low voltage VSS2 to the first node Q-C.

The second circuit S102 may include a second-first transistor T21 and a second-second transistor T22. The second-first transistor T21 and the second-second transistor T22 may be connected to each other in series, and the second-first and second-second transistors T21 and T22 may be connected between the first node Q-C and the sixth input terminal IN6. In addition, a gate electrode of the second-first transistor T21 and a gate electrode of the second-second transistor T22 may be connected to the second node QB. The second-first and second-second transistors T21 and T22 may apply the second low voltage VSS2 to the first node Q-C in response to a voltage at the second node QB. Accordingly, the second circuit S102 may be also referred to as a first node stabilizing circuit.

The third circuit S103 may include a third-first transistor T31, a third-second transistor T32, a third-third transistor T33, a third-fourth transistor T34, and a third-fifth transistor T35.

The third-first transistor T31 may be connected between the second node QB and the third input terminal IN3. The third-second transistor T32 and the third-third transistor T33 may be connected to each other in series, gate electrodes of the third-second and third-third transistors T32 and T33 may be connected to the third input terminal IN3, and the third-second and third-third transistors T32 and T33 may be connected between the third input terminal IN3 and a gate electrode of the third-first transistor T31.

The third-fourth transistor T34 may be connected between the gate electrode of the third-first transistor T31 and the fifth input terminal IN5, and the third-fifth transistor T35 may be connected between the second node QB and the sixth input terminal IN6. A gate electrode of the third-fourth transistor T34 and a gate electrode of the third-fifth transistor T35 may be connected to the first node Q-C.

The third-second and third-third transistors T32 and T33 may apply the first high voltage VDD1 to the gate electrode of the third-first transistor T31 in response to the first high voltage VDD1. The operation of the third-fourth transistor T34 may be controlled by a voltage at the first node Q-C. When the third-fourth transistor T34 is turned on, the first low voltage VSS1 may be transmitted to the gate electrode of the third-first transistor T31.

The third-first transistor T31 may apply the first high voltage VDD1 to the second node QB in response to a volage of the gate electrode of the third-first transistor T31. The operation of the third-fifth transistor T35 may be controlled by a voltage at the first node Q-C. When the third-fifth transistor T35 is turned on, the second low voltage VSS2 may be applied to the second node QB.

The fourth circuit S104 may include a fourth-first transistor T41, a fourth-second transistor T42, and a capacitor C4.

The fourth-first transistor T41 may be connected between the first control terminal CINa and the fourth node N-B. A gate electrode of the fourth-first transistor T41 may be connected to the first node Q-C. The operation of the fourth-first transistor T41 may be controlled in response to the voltage at the first node Q-C. When the fourth-first transistor T41 is turned on, a voltage with a logic high level may be applied to the fourth node N-B.

The fourth-second transistor T42 may be connected between the fourth node N-B and the sixth input terminal IN6. A gate electrode of the fourth-second transistor T42 may be connected to the second node QB. The operation of the fourth-second transistor T42 may be controlled in response to the voltage at the second node QB. When the fourth-second transistor T42 is turned on, the second low voltage VSS2 may be applied to the fourth node N-B.

The capacitor C4 may be connected to the gate electrode of the fourth-first transistor T41 and the fourth node N-B. The capacitor C4 may boost up the voltage at the first node Q-C in response to the volage increase of the fourth node N-B, and this operation may be also referred to as a second boosting operation.

The fifth circuit S105 may include a fifth-first transistor T51 and a fifth-second transistor T52.

The fifth-first transistor T51 may be connected between the second control terminal CINb and the carry output terminal COUT. A gate electrode of the fifth-first transistor T51 may be connected to the first node Q-C. The operation of the fifth-first transistor T51 may be controlled in response to the voltage at the first node Q-C. When the fifth-first transistor T51 is turned on, a logic high level voltage of the second carry signal CR[N] may be applied to the carry output terminal COUT.

The fifth-second transistor T52 may be connected between the carry output terminal COUT and the sixth input terminal IN6. A gate electrode of the fifth-second transistor T52 may be connected to the second node QB. The operation of the fifth-second transistor T52 may be controlled in response to the volage at the second node QB. When the fifth-second transistor T52 is turned on, the second low voltage VSS2 may be applied to the carry output terminal COUT.

The sixth circuit S106 may control a voltage at the third node N-CQ and may be also referred to as a third node control circuit. The sixth circuit S106 may include a sixth-first transistor T61, a sixth-second transistor T62, and a sixth-third transistor T63.

The sixth-first transistor T61 and the sixth-second transistor T62 may be connected to each other in series, and the sixth-first and sixth-second transistors T61 and T62 may have a dual-gate structure. The sixth-first transistor T61 and the sixth-second transistor T62 may be connected between the fourth input terminal IN4 and the third node N-CQ. In addition, a gate electrode of the sixth-first transistor T61 and a gate electrode of the sixth-second transistor T62 may be connected to the first input terminal IN1. The sixth-first and sixth-second transistors T61 and T62 may apply the second high voltage VDD2 to the third node N-CQ in response to the gate on-voltage, e.g., a logic high level, of the first carry signal CR[N−1].

The sixth-third transistor T63 may be connected between the third node N-CQ and the third input terminal IN3. In addition, a gate electrode of the sixth-third transistor T63 may be connected to the second input terminal IN2. The sixth-third transistor T63 may apply the first high voltage VDD1 to the third node N-CQ in response to the gate on-voltage, e.g., a logic high level, of the third carry signal CR[N+1].

The seventh circuit S107 may include a seventh-first transistor T71. The seventh-first transistor T71 may be connected between the third input terminal IN3 and the third node N-CQ. A gate electrode of the seventh-first transistor T71 may be connected to the fourth node N-B. The seventh-first transistor T71 may apply the first high voltage VDD1 to the third node N-CQ in response to the voltage at the fourth node N-B.

The eighth circuit S108 may include an eighth-first transistor T81 and an eighth-second transistor T82.

The eighth-first transistor T81 and the eighth-second transistor T82 may be connected to each other in series, and the eighth-first and eighth-second transistors T81 and T82 may be connected between the third node N-CQ and the fifth input terminal IN5. In addition, a gate electrode of the eighth-first transistor T81 and a gate electrode of the eighth-second transistor T82 may be connected to the second node QB. The eighth-first and eighth-second transistors T81 and T82 may apply the first low voltage VSS1 to the third node N-CQ in response to the voltage at the second node QB. Accordingly, the eighth circuit S108 may be also referred to as a third node stabilizing circuit.

The ninth circuit S109 may include a plurality of output circuits S109s. In the illustrated embodiment, since one stage ST[N] outputs six scan signals, the ninth circuit S109 may include six output circuits S109s. FIG. 6B shows two output circuits, such as a first output circuit and a last output circuit (e.g., a sixth output circuit), as an illustrative embodiment.

Each of the output circuits S109s may include a ninth-first transistor T91, a ninth-second transistor T92, a ninth-third transistor T93, and a capacitor C9. Hereinafter, descriptions will focus on the first output circuit S109s, and since remaining output circuits S109s have substantially the same circuit configuration as the first output circuit S109s, descriptions of the remaining output circuits S109s will be omitted.

The ninth-first transistor T91 may be connected between the first clock terminal CIN1 and the first output terminal OUT1. A gate electrode of the ninth-first transistor T91 may be connected to the branch node Q-1. The ninth-second transistor T92 may be connected between the first node Q-C and the branch node Q-1. A gate electrode of the ninth-second transistor T92 may be connected to the third node N-CQ. The ninth-second transistor T92 may connect the first node Q-C and the branch node Q-1 or may separate the first node Q-C from the branch node Q-1 in response to the voltage at the third node N-CQ.

The operation of the ninth-first transistor T91 may be controlled in response to a voltage at the branch node Q-1. When the ninth-first transistor T91 is turned on, a logic relatively high level voltage of the first scan signal SC1[N] may be output to the first output terminal OUT1.

In the illustrated embodiment, the seventh-first transistor T71 may be turned on at a time point where the fourth node N-B is boosted and may apply the first high voltage VDD1 to the third node N-CQ. The voltage at the first node Q-C may be higher than the first high voltage VDD1 of the third node N-CQ at the time point where the fourth node N-B is boosted. Accordingly, the ninth-second transistor T92 may be turned off. The ninth-second transistor T92 may separate the first node Q-C from the branch node Q-1 in response to the voltage at the third node N-CQ.

When signals are being output to the first, second, third, fourth, fifth and sixth output terminals OUT1, OUT2, OUT3, OUT4, OUT5, and OUT6, the first node Q-C and the branch node Q-1 may be electrically isolated from each other, and the branch nodes Q-1 to Q-6 may also be electrically isolated from one another. Accordingly, even though the voltage at the branch node Q-1 is coupled and changed in accordance with the signal output to the first output terminal OUT1, the effect on other nodes may be eliminated. In an embodiment, these other nodes may be the first node Q-C and the remaining branch nodes among the branch nodes Q-1 to Q-6 excluding the branch node Q-1. Therefore, horizontal line defects caused by brightness differences for each line may be eliminated.

When the second low voltage VSS2 is applied to the first node Q-C in response to the gate on-voltage of the third carry signal CR[N+1], the voltage at the first node Q-C may be lower than the voltage at the third node N-CQ. In this case, the ninth-second transistor T92 may be turned on, the first node Q-C may be connected to the branch node Q-1, and the branch node Q-1 may be discharged.

The ninth-third transistor T93 may be connected between the first output terminal OUT1 and the fifth input terminal IN5. A gate electrode of the ninth-third transistor T93 may be connected to the second node QB. The operation of the ninth-third transistor T93 may be controlled in response to the voltage at the second node QB. When the ninth-third transistor T93 is turned on, the first low voltage VSS1 may be applied to the first output terminal OUT1.

The capacitor C9 may be connected to the branch node Q-1 and the fourth node N-B. The capacitor C9 may boost up the voltage at the branch node Q-1 in response to the voltage increase of the fourth node N-B. When the voltage at the branch node Q-1 increases, the first scan signal SC1[N] having the relatively high voltage may be output without distortion.

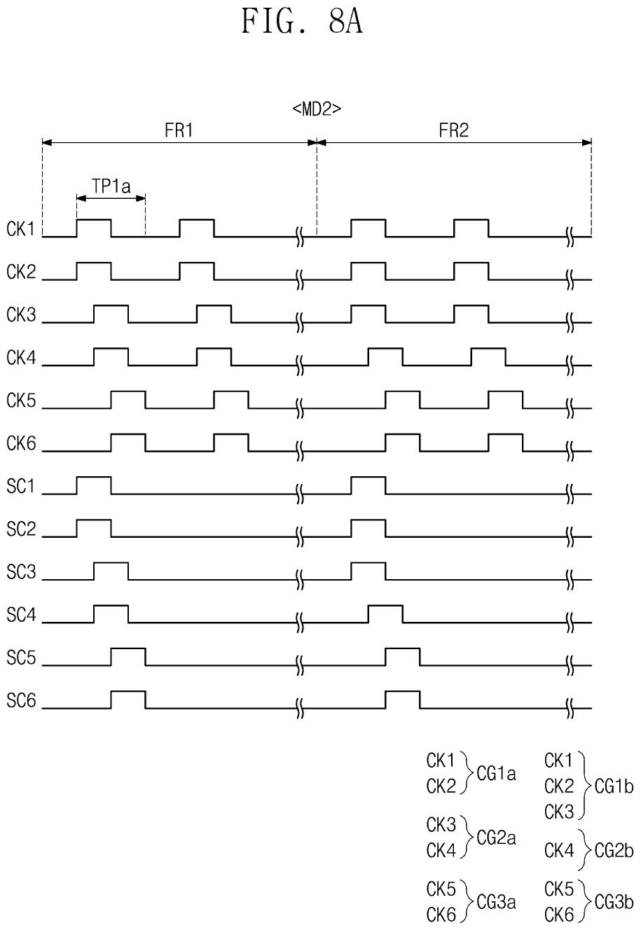

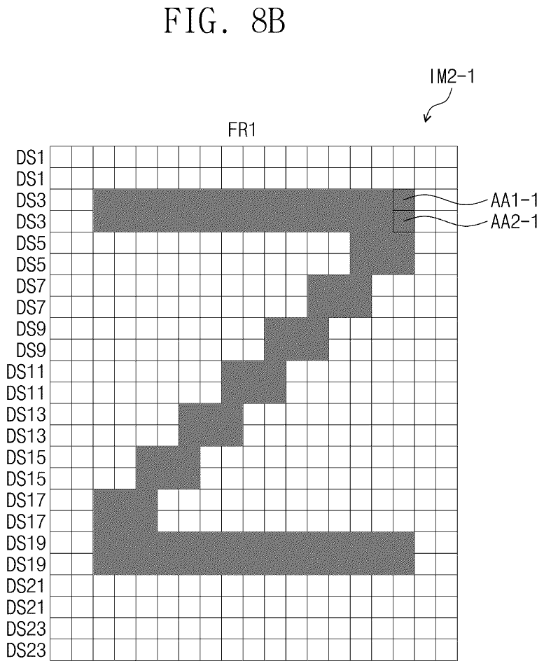

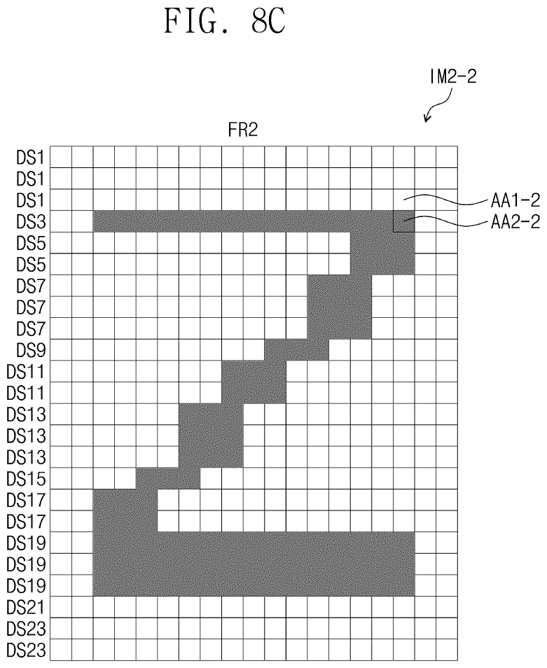

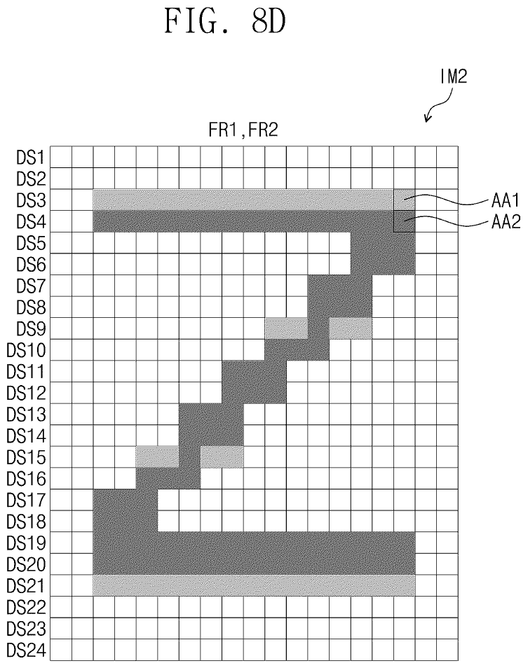

FIG. 7A is a timing diagram showing an embodiment of an operation of the display panel in a first mode according to the disclosure. FIG. 7B is a view showing an image displayed on the display panel according to the timing diagram of FIG. 7A. FIG. 8A is a timing diagram showing an embodiment of an operation of the display panel in a second mode according to the disclosure. FIGS. 8B to 8D are views showing images displayed on the display panel according to the timing diagram of FIG. 8A.

Referring to FIGS. 7A and 8A, the display panel DP (refer to FIG. 1) may selectively operate in the first mode MD1 or the second mode MD2. In the first mode MD1, since the scan signals are sequentially activated, a row data voltage corresponding to each pixel row may be applied to each pixel row, and the display panel DP may display a relatively high-resolution image. In the second mode MD2, since some of the scan signals are simultaneously activated, a length of one frame may be shortened compared to that of the first mode MD1, and the display panel DP may be driven at relatively high speed. Accordingly, the first mode MD1 may be a high-resolution mode, and the second mode MD2 may be a high-refresh rate mode. In an embodiment, the first mode MD1 may be a normal driving mode operating at a first frequency, and the second mode MD2 may be a high-frequency driving mode operating at a second frequency higher than the first frequency. In an embodiment, the first frequency may be about 240 hertz (Hz), and the second frequency may be about 480 Hz.

Referring to FIGS. 5A, 7A, and 7B, the display panel DP (refer to FIG. 1) may operate in the first mode MD1 and may display images on a per-frame basis. A first frame FR1 and a second frame FR2 may be consecutive frames. Each of the first frame FR1 and the second frame FR2 may include a first period TP1, a second period TP2, a third period TP3, and a fourth period TP4. In FIG. 7A, the second period TP2 may partially overlap the first period TP1, the third period TP3 may partially overlap the second period TP2, and the fourth period TP4 may partially overlap the third period TP3, however, the disclosure should not be limited thereto or thereby. In an embodiment, the first period TP1, the second period TP2, the third period TP3, and the fourth period TP4 may not overlap each other.

Each of the first to fourth periods TP1 to TP4 may be defined as a period in which six scan signals are activated in each of the first to fourth driving stages SC-ST1 to SC-ST4. In an embodiment, when the clock signals are activated, the clock signals may have a first voltage level, e.g., a relatively high voltage level, and when the clock signals are deactivated, the clock signals may have a second voltage level, e.g., a relatively low voltage level. That is, during the first period TP1, first to sixth scan signals SC1 to SC6 may be activated through the driving scan lines SCLs in the first driving stage SC-ST1, and during the second period TP2, seventh to twelfth scan signals may be activated in the second driving stage SC-ST2. Similarly, during the third period TP3, thirteenth to eighteenth scan signals may be activated through the driving scan lines SCLs in the third driving stage SC-ST3, and during the fourth period TP4, nineteenth to twenty-fourth scan signals may be activated in the fourth driving stage SC-ST4. When the scan signals are activated, the pixels PX may be driven in response to the scan signals provided through the driving scan lines SCLs.

When the display panel DP (refer to FIG. 1) operates in the first mode MD1, k clock signals may be sequentially activated. In an embodiment, the first to sixth clock signals CK1 to CK6 may be sequentially activated during the first period TP1. That is, the second clock signal CK2 may be activated at a time point where the first clock signal CK1 is deactivated, e.g., a falling edge, and the third clock signal CK3 may be activated at a time point where the second clock signal CK2 is deactivated. During the first period TP1, the first to sixth scan signals SC1 to SC6 corresponding to the first to sixth clock signals CK1 to CK6 may be activated at time points where the first to sixth clock signals CK1 to CK6 are sequentially activated, e.g., rising edges.

The first to sixth scan signals SC1 to SC6 may be the driving scan signals respectively provided through the driving scan lines SCLs connected to the first driving stage SC-ST1. In an embodiment, the first to sixth scan signals SC1 to SC6 may be the sensing scan signals respectively provided through the sensing scan lines SSLs connected to the first sensing stage SS-ST1. Hereinafter, the driving scan signals will be mainly described among the scan signals except the sensing scan signals.

In an embodiment, odd-numbered stages SC-ST1 and SC-ST3 among the driving stages SC-ST1 to SC-ST4 may receive the first to sixth clock signals CK1 to CK6 to output the first to sixth scan signals SC1 to SC6, and even-numbered stages SC-ST2 and SC-ST4 among the driving stages SC-ST1 to SC-ST4 may receive seventh to twelfth clock signals to output the seventh to twelfth scan signals. The seventh to twelfth clock signals may each have a phase delayed by a selected time from the first to sixth clock signals CK1 to CK6. The seventh to twelfth clock signals may be sequentially activated during the second period TP2. The seventh to twelfth scan signals corresponding to the seventh to twelfth clock signals may be activated at time points where the seventh to twelfth clock signals are sequentially activated.

The seventh to twelfth scan signals may be the driving scan signals respectively provided through the driving scan lines SCLs connected to the second driving stage SC-ST2.

The first to sixth clock signals CK1 to CK6 may be sequentially activated during the third period TP3. The thirteenth to eighteenth scan signals corresponding to the first to sixth clock signals CK1 to CK6 may be activated at time points where the first to sixth clock signals CK1 to CK6 are sequentially activated during the third period TP3.

The thirteenth to eighteenth scan signals may be the driving scan signals respectively provided through the driving scan lines SCLs connected to the third driving stage SC-ST3.

The seventh to twelfth clock signals may be sequentially activated during the fourth period TP4. The nineteenth to twenty-fourth scan signals corresponding to the seventh to twelfth clock signals may be activated at time points where the seventh to twelfth clock signals are sequentially activated.

The nineteenth to twenty-fourth scan signals may be the driving scan signals respectively provided through the driving scan lines SCLs connected to the fourth driving stage SC-ST4.

FIG. 7B shows a first image IM1 displayed on the display panel DP (refer to FIG. 1) as an illustrative embodiment. In an embodiment, the first image IM1 may be represented by twenty-four pixel rows. The twenty-four pixel rows may be connected to corresponding driving scan lines SCLs and may receive first to twenty-fourth scan signals, respectively. Each of the first to twenty-fourth scan signals may be the driving scan signal provided from the driving scan line SCLs. Each of the first to twenty-fourth scan signals may be connected to pixels arranged in one pixel row to control the operation of the pixels.

First to twenty-fourth row data voltages DS1 to DS24 may be applied to the first to twenty-fourth pixel rows, respectively, at time points where the first to twenty-fourth scan signals are activated. In the illustrated embodiment, the row data voltage refers to the set of data voltages applied to the pixels in each pixel row. That is, the first row data voltage DS1 may be the set of the data voltages applied to the pixels arranged in the first pixel row, and the second row data voltage DS2 may be the set of the data voltages applied to the pixels arranged in the second pixel row. When the display panel DP operates in the first mode MD1, the first to twenty-fourth row data voltages DS1 to DS24 may be applied to the first to twenty-fourth pixel rows, respectively, and the pixel rows may receive different row data voltages from each other. Accordingly, the display panel DP may display the first image IM1 with relatively high resolution.

Hereinafter, in some other embodiments, images displayed on the display panel DP (refer to FIG. 1) may be represented by the pixels PX arranged in the twenty-four pixel rows connected to the driving scan line SCLs as shown in FIG. 7B.

Referring to FIG. 8A, the display panel DP (refer to FIG. 1) may operate in the second mode MD2 and may display images on a per-frame basis. When the display panel DP (refer to FIG. 1) operates in the second mode MD2, some of the first to sixth clock signals CK1 to CK6 may be simultaneously activated during a first period TP1a. The first to sixth scan signals SC1 to SC6 corresponding to the first to sixth clock signals CK1 to CK6 may be activated at time points where the first to sixth clock signals CK1 to CK6 are activated. Hereinafter, since the process of activating the scan signals corresponding to the clock signals in the second mode MD2 is similar to the process of activating the scan signals by the clock signals in the first mode MD1 of shown in FIG. 7A, except for the fact that some of the clock signals are activated simultaneously causing simultaneous activation of the scan signals, a detailed description thereof is omitted.

Referring to FIG. 8A, when the display panel DP (refer to FIG. 1) operates in the second mode MD2, k clock signals may be grouped into k/2 clock groups, and among the k clock signals, the clock signals within the same clock group may be activated simultaneously. That is, at least two clock signals among the k clock signals may be activated simultaneously. In the illustrated embodiment, k is an integer greater than or equal to 4.

In an embodiment, the first to sixth clock signals CK1 to CK6 may be grouped by associating clock signals that are activated simultaneously within each frame FR1 or FR2. FIG. 8A shows the first to sixth clock signals CK1 to CK6 that are grouped into three clock groups (hereinafter, respectively referred to as first, second, and third clock groups) as an illustrative embodiment, however, the disclosure should not be limited thereto or thereby. In the first frame FR1, the first to sixth clock signals CK1 to CK6 may be grouped into a first clock group CG1a, a second clock group CG2a, and a third clock group CG3a, and in the second frame FR2, the first to sixth clock signals CK1 to CK6 may be grouped into a first clock group CG1b, a second clock group CG2b, and a third clock group CG3b.

In the first frame FR1, at least one clock group among the k/2 clock groups may include p clock signals, and when a first clock signal among the p clock signals is activated, remaining p-1 clock signals may be activated in synchronization with the activation time point of the first clock signal. In the second frame FR2, at least one clock group among the k/2 clock groups may include q, which is different from the p, clock signals, and when a first clock signal among the q clock signals is activated, remaining q-1 clock signals may be activated in synchronization with the activation time point of the first clock signal. In the illustrated embodiment, both p and q are integers smaller than k. In an embodiment, each of the first, second, and third clock groups CG1a, CG2a, and CG3a may include two clock signals in the first frame FR1, and at least one of the first, second, and third clock groups CG1b, CG2b, and CG3b may include more or less than two clock signals in the second frame FR2.

That is, the first clock group CG1a may include the first clock signal CK1 and the second clock signal CK2 in the first frame FR1. The second clock signal CK2 may be activated simultaneously with the first clock signal CK1 in synchronization with a time point where the first clock signal CK1 is activated. In the first frame FR1, the second clock group CG2a may include the third clock signal CK3 and the fourth clock signal CK4, and the fourth clock signal CK4 may be activated simultaneously with the third clock signal CK3 in synchronization with a time point where the third clock signal CK3 is activated. In the first frame FR1, the third clock group CG3a may include the fifth clock signal CK5 and the sixth clock signal CK6, and the sixth clock signal CK6 may be activated simultaneously with the fifth clock signal CK5 in synchronization with a time point where the fifth clock signal CK5 is activated.

In the first frame FR1, at least one clock group among the k/2 clock groups may output p scan signals, which are activated at the activation time points of the p clock signals, to p scan lines among k scan lines, respectively. In the second frame FR2, at least one clock group among the k/2 clock groups may output q scan signals, which are activated at the activation time points of the q clock signals, to q scan lines among the k scan lines, respectively.

Some of the first to sixth scan signals SC1 to SC6 may be activated simultaneously in response to the clock signals activated simultaneously in the first frame FR1. That is, in the first frame FR1, the first scan signal SC1 and the second scan signal SC2 may be activated simultaneously, the third scan signal SC3 and the fourth scan signal SC4 may be activated simultaneously, and the fifth scan signal SC5 and the sixth scan signal SC6 may be activated simultaneously. The first to sixth scan signals SC1 to SC6 may be output to corresponding driving scan line SCLs (refer to FIG. 5A), respectively. As described above, as two scan signals are activated simultaneously in the second mode MD2, a time desired to activate six scan lines connected to each stage, i.e. a duration of the first period TP1a, may be reduced.

In the second frame FR2, the first clock group CG1b may include the first to third clock signals CK1 to CK3. The second clock signal CK2 and the third clock signal CK3 may be activated simultaneously with the first clock signal CK1 in synchronization with the activation time point of the first clock signal CK1. In the second frame FR2, the second clock group CG2b may include the fourth clock signal CK4. In the second frame FR2, the third clock group CG3b may include the fifth clock signal CK5 and the sixth clock signal CK6. The sixth clock signal CK6 may be activated simultaneously with the fifth clock signal CK5 in synchronization with the activation time point of the fifth clock signal CK5.

In the second frame FR2, some of the first to sixth scan signals SC1 to SC6 may be activated simultaneously in response to some clock signals of the first to sixth clock signals CK1 to CK6, which are activated simultaneously. That is, in the second frame FR2, the first to third scan signals SC1 to SC3 may be activated simultaneously, and the fifth scan signal SC5 and the sixth scan signal SC6 may be activated simultaneously.

In the illustrated embodiment, the third clock signal CK3 may be included in the second clock group CG2a in the first frame FR1 and may be included in the first clock group CG1b in the second frame FR2. Since the third clock signal CK3 is activated in different periods of the first frame FR1 and second frame FR2, the third scan signal SC3 corresponding to the third clock signal CK3 may be activated in different periods of the first frame FR1 and the second frame FR2.

Referring to FIGS. 8A, 8B, 8C, and 8D, the display panel DP (refer to FIG. 1) operating in the second mode MD2 may display images in response to scan signals that are activated simultaneously.

FIG. 8B shows a second-first image IM2-1 displayed during the first frame FR1 by the display panel DP (refer to FIG. 1) operating in the second mode MD2 as an illustrative embodiment, and FIG. 8C shows a second-second image IM2-2 displayed during the second frame FR2 following the first frame FR1 by the display panel DP operating in the second mode MD2 as an illustrative embodiment. FIG. 8D shows a second image IM2 that a user may actually perceive based on the images displayed on the display panel DP during the first frame FR1 and the second frame FR2 as an illustrative embodiment. That is, the second image IM2 may be an image in which the second-first image IM2-1 and the second-second image IM2-2 are overlaid.

In the second mode MD2, when two clock signals included in each of the first, second, and third clock groups CG1a, CG2a, and CG3a in the first frame FR1 are activated, one row data voltage may be applied to two pixel rows.

In the first frame FR1, the first scan signal SC1 and the second scan signal SC2 may be activated simultaneously and the pixels arranged in the first and second pixel rows may be driven simultaneously to display the second-first image IM2-1 of FIG. 8B. Accordingly, the first row data voltage DS1 applied to the pixels arranged in the first pixel row may also be applied to the pixels arranged in the second pixel row. That is, the image displayed in the first pixel row by the first row data voltage DS1 may be the same as the image displayed in the second pixel row.

In the first frame FR1, the third scan signal SC3 and the fourth scan signal SC4 may be activated simultaneously, and the pixels arranged in the third and fourth pixel rows may be driven simultaneously. Therefore, the third row data voltage DS3 applied to the pixels arranged in the third pixel row may also be applied to the pixels arranged in the fourth pixel row. That is, the image displayed in the third pixel row by the third row data voltage DS3 may be the same as the image displayed in the fourth pixel row.

In the first frame FR1, the fifth scan signal SC5 and the sixth scan signal SC6 may be activated simultaneously, and the pixels arranged in the fifth and sixth pixel rows may be driven simultaneously. Accordingly, the fifth row data voltage DS5 applied to the pixels arranged in the fifth pixel row may also be applied to the pixels arranged in the sixth pixel row. That is, the image displayed in the fifth pixel row by the fifth row data voltage DS5 may be the same as the image displayed in the sixth pixel row.

In the second frame FR2, the first to third scan signal SC1 to SC3 may be activated simultaneously and the pixels arranged in the first to third pixel rows may be driven simultaneously to display the second-second image IM2-2 of FIG. 8C. Accordingly, the first row data voltage DS1 applied to the pixels arranged in the first pixel row may also be applied to the pixels arranged in the second and third pixel rows. That is, the image displayed in the first pixel row by the first row data voltage DS1 may be the same as the image displayed in the second and third pixel rows.

The pixels arranged in the fourth pixel row receiving the fourth scan signal SC4 in the second frame FR2 may receive the third row data voltage DS3 corresponding to the third pixel row.

In the second frame FR2, the fifth scan signal SC5 and the sixth scan signal SC6 may be activated simultaneously, and the pixels arranged in the fifth and sixth pixel rows may be driven simultaneously. Accordingly, the fifth row data voltage DS5 applied to the pixels arranged in the fifth pixel row may also be applied to the pixels arranged in the sixth pixel row. That is, the image displayed in the fifth pixel row by the fifth row data voltage DS5 may be the same as the image displayed in the sixth pixel row.

The user may perceive the second image IM2 in which the second-first image IM2-1 displayed during the first frame FR1 and the second-second image IM2-2 displayed during the second frame FR2 are overlaid as shown in FIG. 8D. An average of a grayscale value of the second-first image IM2-1 displayed in the first frame FR1 and a grayscale value of the second-second image IM2-2 displayed in the second frame FR2 may be expressed as a grayscale value of the second image IM2. In detail, since a first-first area AA1-1 of the second-first image IM2-1 may represent a black grayscale and a first-second area AA1-2 of the second-second image IM2-2 may represent a white grayscale, a grayscale corresponding to the average of the black and white grayscales may be perceived in a first area AA1 of the second image IM2. In addition, since a second-first area AA2-1 of the second-first image IM2-1 may represent the black grayscale and a second-second area AA2-2 of the second-second image IM2-2 may represent the black grayscale, the black grayscale may be also perceived in a second area AA2 of the second image IM2.

When the display device DD (refer to FIG. 1) according to the disclosure operates in the second mode MD2, some clock signals may be activated simultaneously, and thus, the display device DD (refer to FIG. 1) may operate in the high-refresh rate mode compared to the first mode MD1. In addition, when the clock signals that are activated simultaneously in the first frame FR1 and the clock signals that are activated simultaneously in the second frame FR2 are set different from each other (hereinafter, also referred to as a clock dithering method), a grayscale difference may occur between the second-first image IM2-1 displayed in the first frame FR1 and the second-second image IM2-2 displayed in the second frame FR2. In this case, since the user perceives the second image IM2 in which the second-first image IM2-1 and the second-second image IM2-2 are overlaid, the user may perceive an image displayed in a variety of grayscale tones than those actually displayed by the display panel DP. Accordingly, the display device to which the clock dithering method is applied in the second mode MD2 may provide images with relatively high resolution and improved display quality to the user even when driven at high-speed.

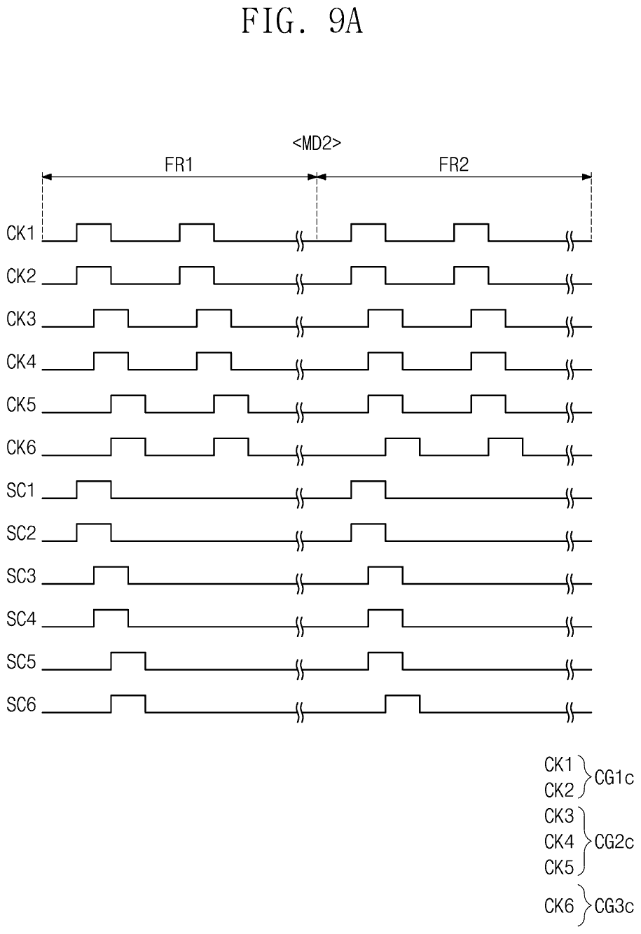

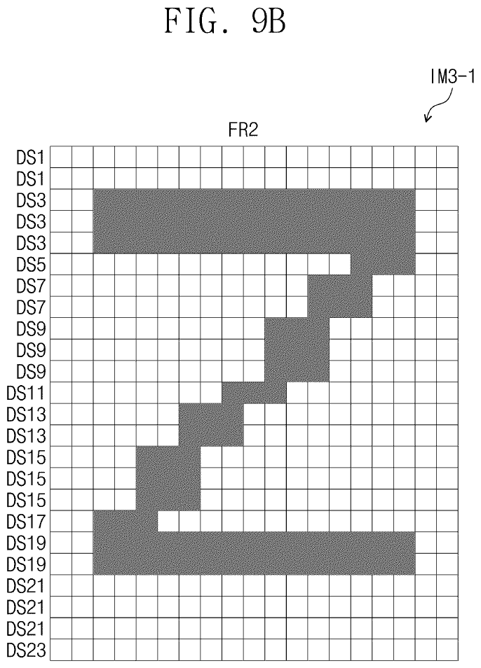

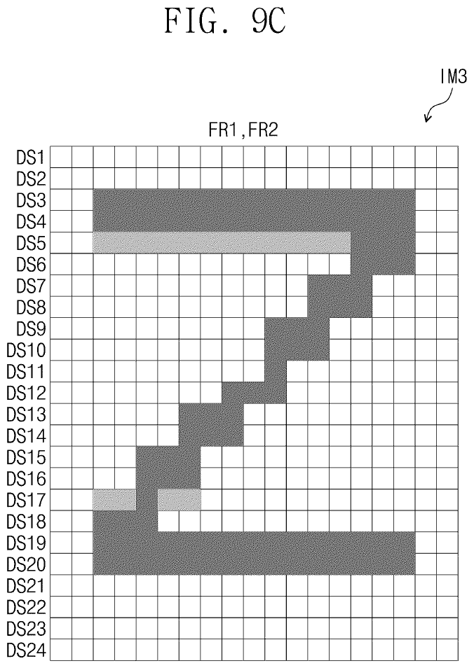

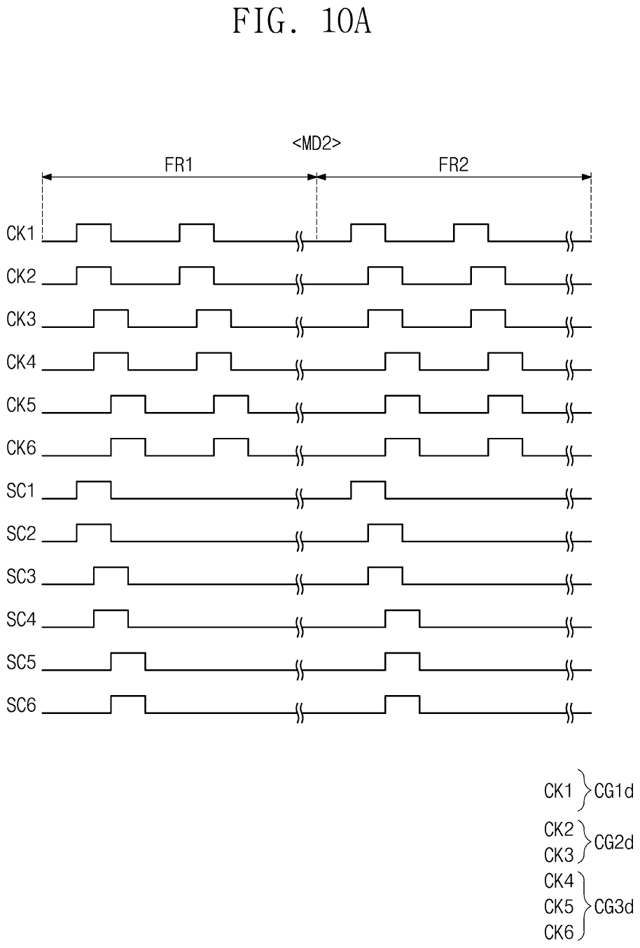

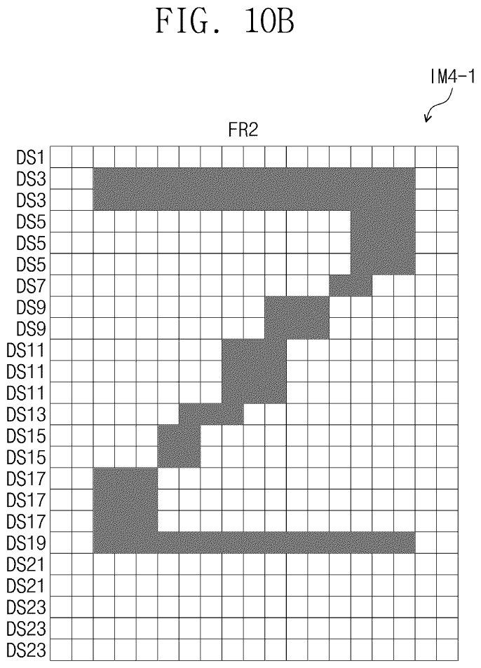

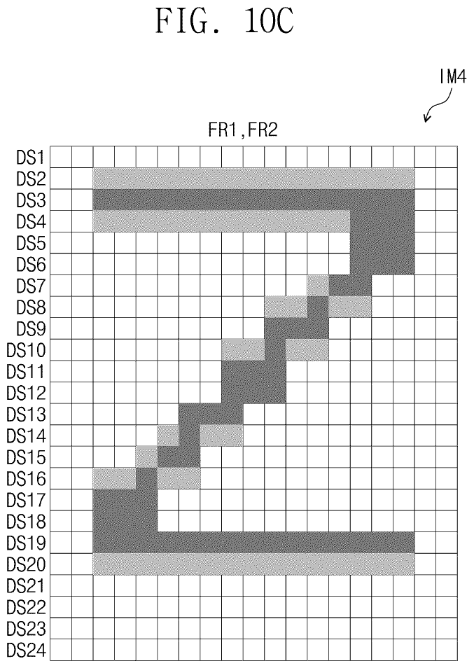

FIG. 9A is a timing diagram showing an embodiment of an operation of a display panel in a second mode according to the disclosure. FIGS. 9B and 9C are views showing images displayed on the display panel according to the timing diagram of FIG. 9A. FIG. 10A is a timing diagram showing an embodiment of an operation of a display panel in a second mode according to the disclosure. FIGS. 10B and 10C are views showing images displayed on the display panel according to the timing diagram of FIG. 10A.

Referring to FIGS. 9A and 10A, the display panel DP may operate in the second mode MD2 and may display images on a per-frame basis. Time points at which first to sixth clock signals CK1 to CK6 are activated and first to sixth scan signals SC1 to SC6 are activated in a first frame FR1 of FIG. 9A and FIG. 10A is similar to the time points at which the first to sixth clock signals CK1 to CK6 are activated and the first to sixth scan signals SC1 to SC6 are activated in the first frame FR1 of FIG. 8A, and thus, details thereof are omitted. Accordingly, an image displayed on the display panel DP in the first frame FR1 of FIGS. 9A and 10A may be the second-first image IM2-1 of FIG. 8B.

In an embodiment, referring to FIGS. 9A, 9B, and 9C, a first clock group CG1c may include the first clock signal CK1 and the second clock signal CK2 in a second frame FR2 of FIG. 9A. The second clock signal CK2 may be activated simultaneously with the first clock signal CK1 in synchronization with an activation time point of the first clock signal CK1. In the second frame FR2, a second clock group CG2c may include the third, fourth, and fifth clock signals CK3, CK4, and CK5. The fourth and fifth clock signals CK4 and CK5 may be activated simultaneously with the third clock signal CK3 in synchronization with an activation time point of the third clock signal CK3. In the second frame FR2, a third clock group CG3c may include the sixth clock signal CK6.

In the second frame FR2 of FIG. 9A, some of the first to sixth scan signals SC1 to SC6 may be activated simultaneously in response to some clock signals, which are activated simultaneously, among the first to sixth clock signals CK1 to CK6. That is, in the second frame FR2, the first scan signal SC1 and the second scan signal SC2 may be activated simultaneously, and the third to fifth scan signals SC3 to SC5 may be activated simultaneously.

FIG. 9B shows a third-first image IM3-1 displayed during the second frame FR2 by the display panel DP operating in the second mode MD2 as an illustrative embodiment. In the second frame FR2, the first scan signal SC1 and the second scan signal SC2 may be activated simultaneously to display the third-first image IM3-1, and the pixels arranged in first and second pixel rows may be driven simultaneously. Accordingly, a first row data voltage DS1 applied to the pixels arranged in the first pixel row may also be applied to the pixels arranged in the second pixel row. That is, an image displayed in the first pixel row by the first row data voltage DS1 may be the same as an image displayed in the second pixel row. In addition, the third to fifth scan signals SC3 to SC5 may be activated simultaneously, and the pixels arranged in third to fifth pixel row may be driven simultaneously. Accordingly, a third row data voltage DS3 applied to pixels arranged in the third pixel row may also be applied to pixels arranged in the fourth and fifth pixel rows. That is, an image displayed in the third pixel row by the third row data voltage DS3 may be the same as an image displayed in the fourth and fifth pixel rows. After the third to fifth scan signals SC3 to SC5 are activated, the sixth scan signal SC6 may be activated, and pixels arranged in a sixth pixel row may be driven. A fifth row data voltage DS5 applied to the pixels arranged in the fifth pixel row may be applied to the pixels arranged in the sixth pixel row.

FIG. 9C shows a third image IM3 that a user may actually perceive based on the image displayed on the display panel DP during the first frame FR1 and the second frame FR2 of FIG. 9A as an illustrative embodiment. That is, the third image IM3 may be an image in which the second-first image IM2-1 (refer to FIG. 8B) and the third-first image IM3-1 are overlaid.

In an embodiment, referring to FIGS. 10A, 10B, and 10C, a first clock group CG1d may include the first clock signal CK1 in a second frame FR2 of FIG. 10B. A second clock group CG2d may include the second clock signal CK2 and the third clock signal CK3 in the second frame FR2. The third clock signal CK3 may be activated simultaneously with the second clock signal CK2 in synchronization with an activation time point of the second clock signal CK2. In the second frame FR2, a third clock group CG3d may include the fourth to sixth clock signals CK4 to CK6. The fifth clock signal CK5 and the sixth clock signal CK6 may be activated simultaneously with the fourth clock signal CK4 in synchronization with an activation time point of the fourth clock signal CK4.

In the second frame FR2 of FIG. 10A, some of the first to sixth scan signals SC1 to SC6 may be activated simultaneously in response to some clock signals, which are activated simultaneously, among the first to sixth clock signals CK1 to CK6. That is, in the second frame FR2, the second scan signal SC2 and the third scan signal SC3 may be activated simultaneously, and the fourth to sixth scan signals SC4 to SC6 may be activated simultaneously.

FIG. 10B shows a fourth-first image IM4-1 displayed during the second frame FR2 by the display panel DP operating in the second mode MD2 as an illustrative embodiment. In the second frame FR2, the first scan signal SC1 may be activated to display the fourth-first image IM4-1, and pixels arranged in a first pixel row may be driven. A first row data voltage DS1 may be applied to the pixels arranged in the first pixel row. The second scan signal SC2 and the third scan signal SC3 may be activated simultaneously, and pixels arranged in second and third pixel rows may be driven simultaneously. Accordingly, a third row data voltage DS3 applied to pixels arranged in the third pixel row may also be applied to pixels arranged in a second pixel row. That is, an image display in the third pixel row by the third row data voltage DS3 may be the same as an image display in the second pixel row. In addition, the fourth to sixth scan signals SC4 to SC6 may be activated simultaneously, and pixels arranged in fourth to sixth pixel rows may be driven simultaneously. Accordingly, a fifth row data voltage DS5 applied to the pixels arranged in the fifth pixel row may also be applied to the pixels arranged in the fourth and sixth pixel rows. That is, an image displayed in the fifth pixel row by the fifth row data voltage DS5 may be the same as images displayed in the fourth and sixth pixel rows.

FIG. 10C shows a fourth image IM4 that the user may actually perceive based on the image displayed on the display panel DP during the first frame FR1 and the second frame FR2 of FIG. 10A as an illustrative embodiment. That is, the fourth image IM4 may be an image in which the second-first image IM2-1 (refer to FIG. 8B) and the fourth-first image IM4-1 are overlaid.

In FIGS. 8A to 10C, embodiments each in which the configuration of the clock signals included in each clock group is changed in units of two frames are described, but the disclosure should not be limited thereto or thereby. In an embodiment, the configuration of the clock signals included in each clock group may be changed in units of two or more frames.

Hereinafter, an embodiment in which the configuration of clock signals included in each clock group is changed in units of four frames will be described.

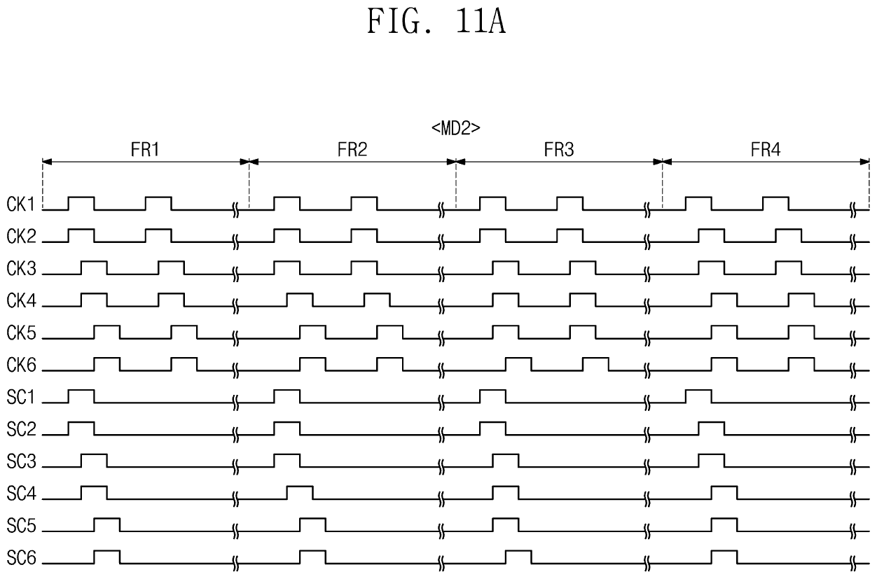

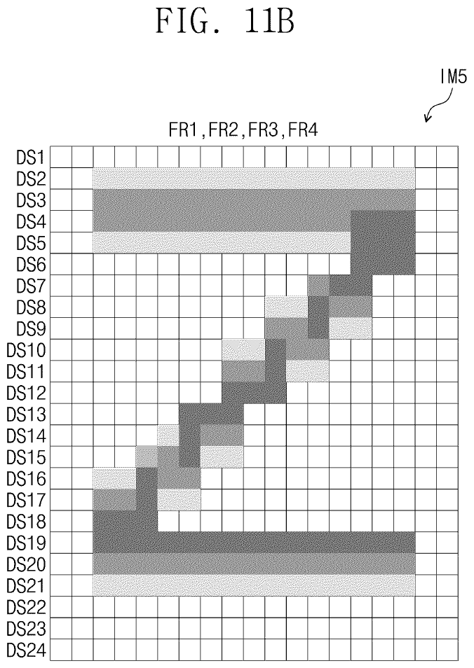

FIG. 11A is a timing diagram showing an embodiment of an operation of a display panel in a second mode according to the disclosure. FIG. 11B is a view showing an image displayed on the display panel according to the timing diagram of FIG. 11A.

Referring to FIG. 11A, the display panel DP may operate in the second mode MD2 and may display images during a first frame FR1, a second frame FR2 following the first frame FR1, a third frame FR3 following the second frame FR2, and a fourth frame FR4 following the third frame FR3. At least one clock group may include p clock signals in the first frame FR1, and at least one clock group may include q clock signals in the second frame FR2. At least one clock group may include g clock signals in the third frame FR3, and at least one clock group may include h clock signals in the fourth frame FR4. In the illustrated embodiment, q and p may be different from each other, g may be different from p and q, and h may be different from p and g. In addition, both g and h are integers less than k. However, the disclosure should not be limited thereto or thereby, and the clock group in each frame may include various clock signals as long as the effect of displaying different images from the same image data in each frame is achieved.

According to the display panel DP driven by the timing diagram shown in FIG. 11A, the configuration of the clock signals included in the clock group may be changed in each of the first to fourth frames FR1 to FR4. In an embodiment, the configuration of the clock group in the first frame FR1 may be the same as the configuration of the first to third clock groups CG1a to CG3a in the first frame FR1 of FIG. 8A, and the configuration of the clock group in the second frame FR2 may be the same as the configuration of the first to third clock groups CG1b to CG3b in the second frame FR2 of FIG. 8A. Accordingly, the display panel DP may display the second-first image IM2-1 of FIG. 8B in the first frame FR1, and the display panel DP may display the second-second image IM2-2 of FIG. 8C in the second frame FR2. In addition, the configuration of the clock group in the third frame FR3 may be the same as the configuration of the first to third clock groups CG1c to CG3c of FIG. 9A in the second frame FR2, and the configuration of the clock group in the fourth frame FR4 may be the same as the configuration of the first to third clock groups CG1d to CG3d in the second frame FR2 of FIG. 10A. Accordingly, the display panel DP may display the third-first image IM3-1 of FIG. 9B in the third frame FR3, and the display panel DP may display the fourth-first image IM4-1 of FIG. 10B in the fourth frame FR4.

FIG. 11B shows a fifth image IM5 that the user may actually perceive based on the images displayed on the display panel DP during the first to fourth frames FR1 to FR4 as an illustrative embodiment. That is, the fifth image IM5 may be an image in which the second-first image IM2-1 of FIG. 8B, the second-second image IM2-2 of FIG. 8C, the third-first image IM3-1 of FIG. 9B, and the fourth-first image IM4-1 of FIG. 10B are overlaid.

When the display device DD (refer to FIG. 1) according to the disclosure operates in the second mode MD2, some clock signals may be activated simultaneously, and thus, the display device DD (refer to FIG. 1) may operate in the high-refresh rate mode compared to the first mode MD1. In addition, when the clock signals activated simultaneously in the first frame FR1 and the clock signals activated simultaneously in each of the second, third, and fourth frames FR2, FR3, and FR4 are set different from each other, differences may arise among the images displayed in the first, second, third, and fourth frames FR1, FR2, FR3, and FR4. Since the fifth image IM5 is displayed across four frames, the fifth image IM5 may include a wider range of grayscales compared to the image in which images from two frames are overlaid. Accordingly, although the second mode MD2 operates at a higher frequency than that of the first mode MD1, the image displayed in second mode MD2 may be perceived by the user as having higher resolution when the clock dithering method is applied. That is, the display device according to the disclosure may provide the image with improved display quality regardless of the operation mode.

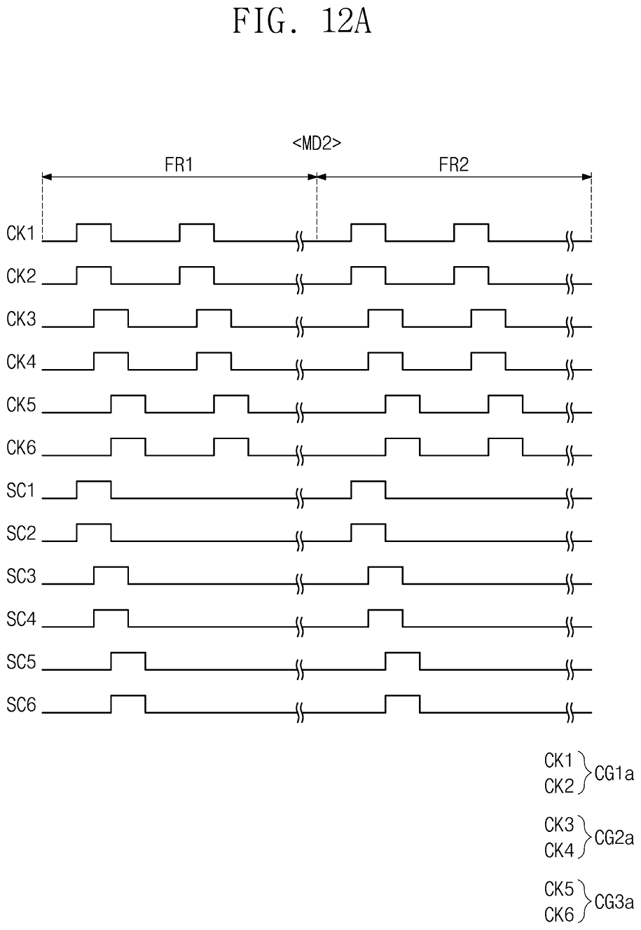

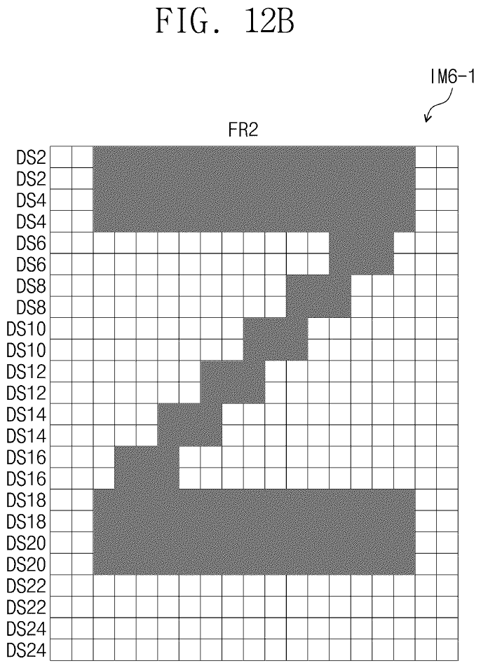

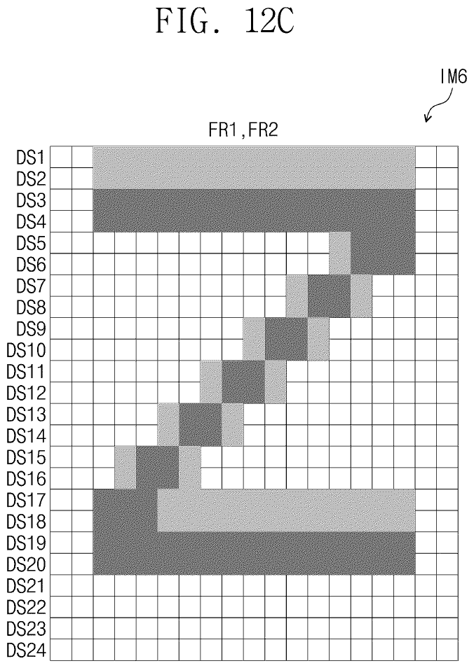

FIG. 12A is a timing diagram showing an embodiment of an operation of a display panel in a second mode according to the disclosure. FIGS. 12B and 12C are views showing images displayed on the display panel according to the timing diagram of FIG. 12A.

Referring to FIG. 12A, the display panel DP may operate in the second mode MD2 and may display images on a per-frame basis. According to the display panel DP driven by the timing diagram shown in FIG. 12A, the configuration of a clock group in a first frame FR1 may be the same as that in a second frame FR2. That is, in the first frame FR1 and the second frame FR2, the clock group may include two clock signals as in the configuration of the first to third clock groups CG1a to CG3a in the first frame FR1 of FIG. 8A.

In the first frame FR1, one row data voltage may be applied to pixels arranged in two pixel rows at a time point at which two clock signals included in each of first to third clock groups CG1a to CG3a are activated. That is, a first clock signal CK1 and a second clock signal CK2 included in the first clock group CG1a may be activated simultaneously in the first frame FR1, and a first row data voltage DS1 corresponding to a first pixel row may be applied to the first pixel row and a second pixel row. In addition, a third clock signal CK3 and a fourth clock signal CK4 included in the second clock group CG2a may be activated simultaneously, and a third row data voltage DS3 corresponding to a third pixel row may be applied to the third pixel row and a fourth pixel row. A fifth clock signal CK5 and a sixth clock signal CK6 included in the third clock group CG3a may be activated simultaneously, and a fifth row data voltage DS5 corresponding to a fifth pixel row may be applied to the fifth pixel row and a sixth pixel row. Therefore, the second-first image IM2-1 of FIG. 8B may be displayed on the display panel DP.

In the second frame FR2, a row data voltage different from the row data voltage applied during the first frame FR1 may be applied to the pixels of two pixel rows at a time point at which two clock signals included in each of the first to third clock groups CG1a to CG3a are activated. That is, the first clock signal CK1 and the second clock signal CK2 included in the first clock group CG1a may be activated simultaneously in the second frame FR2, and a second row data voltage DS2 corresponding to the second pixel row may be applied to the first and second pixel rows. In addition, the third clock signal CK3 and the fourth clock signal CK4 included in the second clock group CG2a may be activated simultaneously, and a fourth row data voltage DS4 corresponding to the fourth pixel row may be applied to the third and fourth pixel rows. The fifth clock signal CK5 and the sixth clock signal CK6 included in the third clock group CG3a may be activated simultaneously, and a sixth row data voltage DS6 corresponding to the sixth pixel row may be applied to the fifth and sixth pixel rows. Accordingly, a sixth-first image IM6-1 of FIG. 12B may be displayed on the display panel DP.

FIG. 12C shows a sixth image IM6 that the user may actually perceive based on the images displayed on the display panel DP during the first frame FR1 and the second frame FR2 as an illustrative embodiment. That is, the sixth image IM6 may be an image in which the second-first image IM2-1 of FIG. 8B and the sixth-first image IM6-1 of FIG. 12B are overlaid.

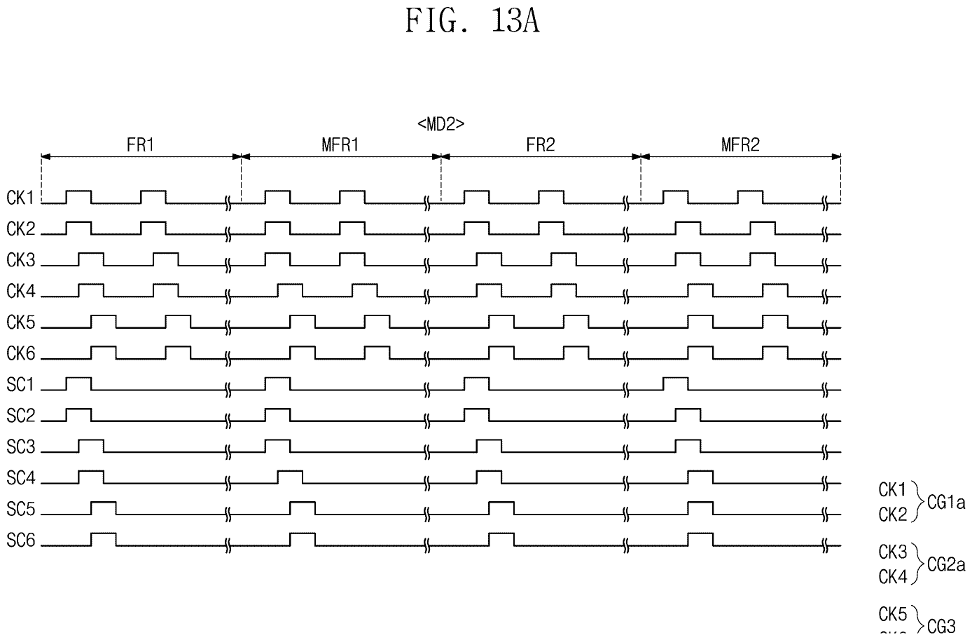

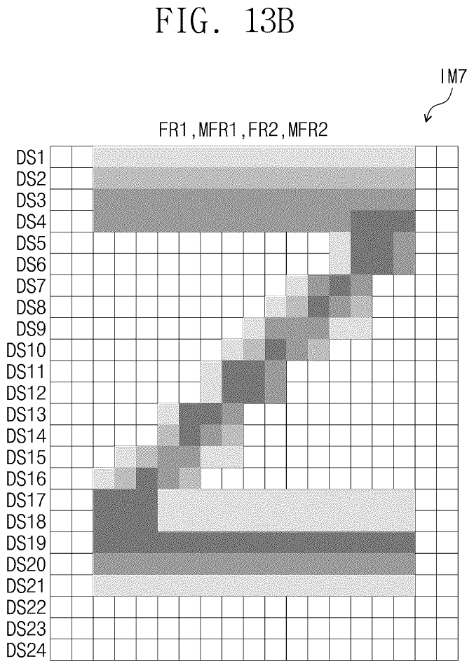

FIG. 13A is a timing diagram showing an embodiment of an operation of a display panel in a second mode according to the disclosure. FIG. 13B is a view showing an image displayed on the display panel according to the timing diagram of FIG. 13A.

Referring to FIG. 13A, the display panel DP may operate in the second mode MD2 and may display images during a first frame FR1, a first intermediate frame MFR1, a second frame FR2, and a second intermediate frame MFR2. The first intermediate frame MFR1 may be disposed between the first frame FR1 and the second frame FR2, and the second intermediate frame MFR2 may follow the second frame FR2.

According to the display panel DP driven by the timing diagram of FIG. 13A, the configuration of clock signals included in a clock group may be changed in each of the first frame FR1, the first intermediate frame MFR1, the second frame FR2, and the second intermediate frame MFR2. In an embodiment, the configuration of the clock group in the first frame FR1 may be the same as the configuration of the first to third clock groups CG1a to CG3a in the first frame FR1 of FIG. 12A, and the configuration of the clock group in the first intermediate frame MFR1 may be the same as the configuration of the first to third clock groups CG1b to CG3b in the second frame FR2 of FIG. 8A. Accordingly, the display panel DP may display the second-first image IM2-1 of FIG. 8B in the first frame FR1, and the display panel DP may display the second-second image IM2-2 of FIG. 8C in the first intermediate frame MFR1. In addition, the configuration of the clock group in the second frame FR2 may be the same as the configuration of the first to third clock groups CG1a to CG3a in the second frame FR2 of FIG. 12B, and the configuration of the clock group in the second intermediate frame MFR2 may be the same as the configuration of the first to third clock groups CG1d to CG3d in the second frame FR2 of FIG. 10A. Therefore, the display panel DP may display the sixth-first image IM6-1 of FIG. 12B in the second frame FR2, and the display panel DP may display the fourth-first image IM4-1 of FIG. 10B in the second intermediate frame MFR2.

According to the timing diagram shown in FIG. 13A, first to third clock groups CG1a to CG3a may have the same configuration in the first frame FR1 and the second frame FR2. In the first frame FR1, one row data voltage may be applied to pixels arranged in two pixel rows at a time point at which two clock signals included in each of the first to third clock groups CG1a to CG3a are activated, and in the second frame FR2, a row data voltage different from the row data voltage applied during the first frame FR1 may be applied to the pixels arranged in two pixel rows. That is, in the first frame FR1 and the second frame FR2, the first clock group CG1a may include a first clock signal CK1 and a second clock signal CK2, and the first clock signal CK1 and the second clock signal CK2 may be activated simultaneously. A first row data voltage DS1 corresponding to a first pixel row may be applied to the first pixel row and a second pixel row during the first frame FR1, and a second row data voltage DS2 corresponding to the second pixel row may be applied to the first and second pixel rows during the second frame FR2. Accordingly, according to the timing diagram shown in FIG. 13A, the display panel DP may display different images in the first frame FR1 and the second frame FR2.

In FIG. 13A, a structure in which the first intermediate frame MFR1 and the second intermediate frame MFR2 having different configurations of clock signals included in each clock group are further included in addition to the first frame FR1 and the second frame FR2 having the same configuration of clock signals included in each clock group is shown. However, the disclosure should not be limited thereto or thereby, and the clock group may include various clock signals in each frame as long as the effect of displaying different images from the same image data in each frame is achieved.

FIG. 13B shows a seventh image IM7 that the user may actually perceive based on the images displayed on the display panel DP during the first frame FR1, the first intermediate frame MFR1, the second frame FR2, and the second intermediate frame MFR2 as an illustrative embodiment. That is, the seventh image IM7 may be an image in which the second-first image IM2-1 of FIG. 8B, the second-second image IM2-2 of FIG. 8C, the sixth-first image IM6-1 of FIG. 12B, and the fourth-first image IM4-1 of FIG. 10B are overlaid.

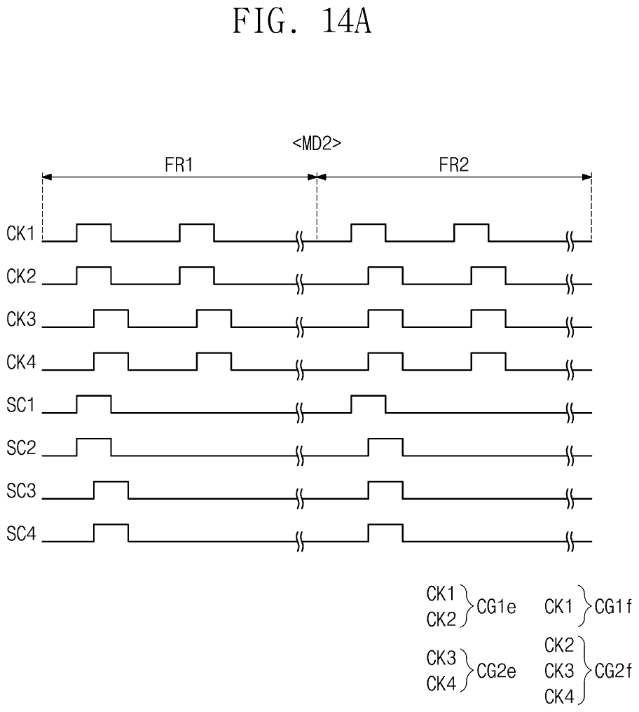

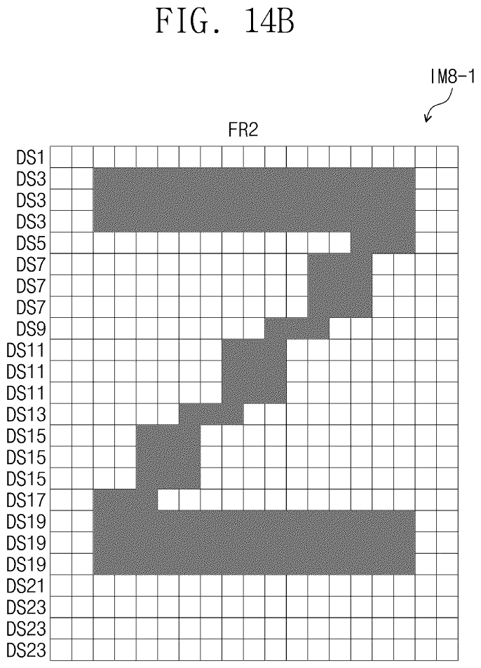

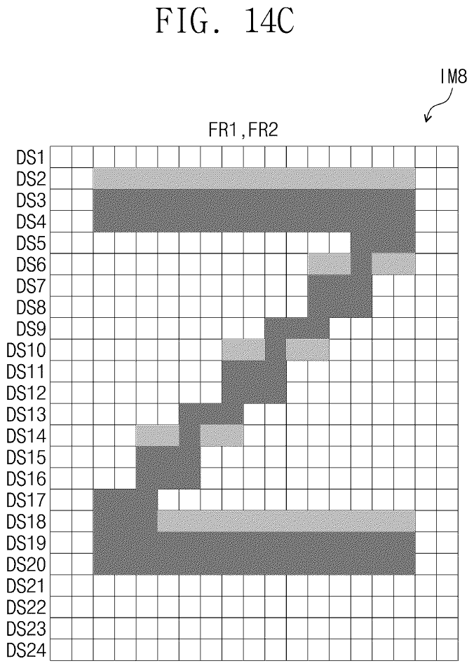

FIG. 14A is a timing diagram showing an embodiment of an operation of a display panel in a second mode according to the disclosure. FIGS. 14B and 14C are views showing images displayed on the display panel according to the timing diagram of FIG. 14A.

Referring to FIGS. 5B and 14A, the display panel DP may operate in the second mode MD2 and may display images on a per-frame basis. In an embodiment, the scan driver 250 may include first to sixth driving stages SC-ST1 to SC-ST6 and first to sixth sensing stages SS-ST1 to SS-ST6. Each of the stages SC-ST1 to SC-ST6 and SS-ST1 to SS-ST6 may receive first to fourth clock signals CK1 to CK4 to activate four scan lines.

When the display panel DP operates in the second mode MD2, the first to fourth clock signals CK1 to CK4 may be grouped by combining the clock signals that are activated simultaneously in each frame FR1 or FR2. FIG. 14A shows that the first to fourth clock signals CK1 to CK4 are grouped into two clock groups as an illustrative embodiment. The first to fourth clock signals CK1 to CK4 may be grouped into a first clock group CG1e and a second clock group CG2e in a first frame FR1, and the first to fourth clock signals CK1 to CK4 may be grouped into a first clock group CG1f and a second clock group CG2f in a second frame FR2.

That is, the first clock group CG1e may include the first clock signal CK1 and the second clock signal CK2 in the first frame FR1. The second clock signal CK2 may be activated simultaneously with the first clock signal CK1 in synchronization with an activation timing of the first clock signal CK1. The second clock group CG2e may include the third clock signal CK3 and the fourth clock signal CK4. The fourth clock signal CK4 may be activated simultaneously with the third clock signal CK3 in synchronization with an activation timing of the third clock signal CK3.

In the second frame FR2, the first clock group CG1f may include the first clock signal CK1, and the second clock group CG2f may include the second to fourth clock signals CK2 to CK4. The third clock signal CK3 and the fourth clock signal CK4 may be activated simultaneously with the second clock signal CK2 in synchronization with an activation timing of the second clock signal CK2.

FIG. 14B shows an eighth-first image IM8-1 displayed during the second frame FR2 by the display panel DP operating in the second mode MD2 as an illustrative embodiment. In the second frame FR2, a first scan signal may be activated and pixels arranged in a first pixel row may be driven to display the eighth-first image IM8-1. A first row data voltage DS1 may be applied to the pixels arranged in the first pixel row. Second to fourth scan signals SC2 to SC4 may be activated simultaneously, and pixels arranged in second to fourth pixel rows may be driven simultaneously. Accordingly, a third row data voltage DS3 applied to the pixels arranged in the third pixel row may also be applied to the pixels arranged in the second and fourth pixel rows. That is, the image displayed in the third pixel row by the third row data voltage DS3 may be the same as the image displayed in the second and fourth pixel rows.

FIG. 14C shows an eighth image IM8 that the user actually perceives based on the images displayed on the display panel DP during the first frame FR1 and the second frame FR2 as an illustrative embodiment. That is, the eighth image IM8 may be an image in which the second-first image IM2-1 (refer to FIG. 8B) and the eighth-first image IM8-1 are overlaid.

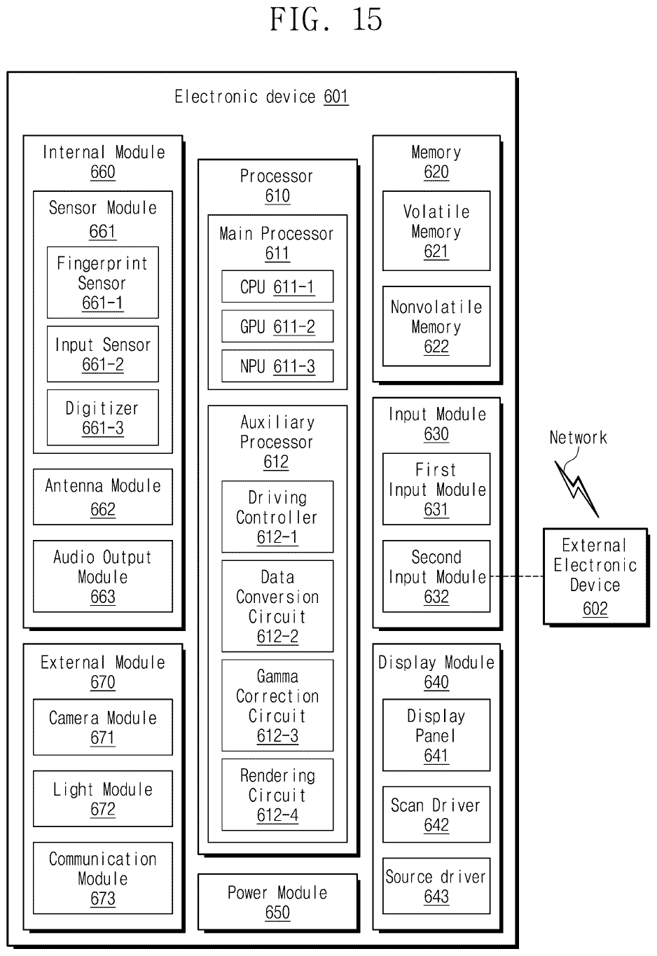

FIG. 15 is a block diagram showing an embodiment of an electronic device according to the disclosure.

Referring to FIG. 15, the electronic device 601 may output various pieces of information through a display module 640 within an operating system. When a processor 610 executes an application stored in a memory 620, the display module 640 may provide application information to a user through a display panel 641.

The processor 610 may obtain an external input through an input module 630 or a sensor module 661 and execute an application corresponding to the external input. In an embodiment, when the user selects a camera icon displayed on the display panel 641, the processor 610 may obtain a user input through an input sensor 661-2 and activate a camera module 671, for example. The processor 610 may transmit image data corresponding to a captured image obtained through the camera module 671 to the display module 640. The display module 640 may display an image corresponding to the captured image through the display panel 641.

In an embodiment, when personal information authentication is executed in the display module 640, a fingerprint sensor 661-1 may acquire input fingerprint information as input data. The processor 610 may compare the input data acquired through the fingerprint sensor 661-1 with authentication data stored in the memory 620 and execute an application according to the comparison result. The display module 640 may display information executed according to a logic of the application through the display panel 641.

In an embodiment, when a music streaming icon displayed on the display module 640 is selected, the processor 610 may obtain a user input through the input sensor 661-2 and activate a music streaming application stored in the memory 620. When a music playback command is input in the music streaming application, the processor 610 may activate an audio output module 663 to provide audio information corresponding to the music playback command to the user.

In the above, the operation of the electronic device 601 is briefly described. Hereinafter, components of the electronic device 601 will be described in detail. Some of the components of the electronic device 601 described below may be integrated and provided as a single component, or one component may be provided after being separated into two or more components.

Referring to FIG. 15, the electronic device 601 may communicate with an external electronic device 602 through a network (e.g., a short-range wireless communication network or a long-range wireless communication network). In an embodiment, the electronic device 601 may include the processor 610, the memory 620, the input module 630, the display module 640, a power module 650, an internal module 660, and an external module 670. In an embodiment, in the electronic device 601, at least one of the above-described components may be omitted or one or more other components may be added. In an embodiment, some of the components (e.g., the sensor module 661, an antenna module 662, or the audio output module 663) may be integrated into another component (e.g., the display module 640).

The processor 610 may execute software to control at least one other component (e.g., a hardware or software component) of the electronic device 601 connected to the processor 610 and may perform various data processing or computational operations. In an embodiment, as at least a part of the data processing or computational operations, the processor 610 may store commands or data received from other components (e.g., the input module 630, the sensor module 661, or a communication module 673) in a volatile memory 621, may process the commands or data stored in the volatile memory 621, and may store result data in a nonvolatile memory 622.

The processor 610 may include a main processor 611 and an auxiliary processor 612. The main processor 611 may include one or both of a central processing unit (“CPU”) 611-1 and an application processor (“AP”). The main processor 611 may further include any one or more of a graphics processing unit (“GPU”) 611-2, a communication processor (“CP”), and an image signal processor (“ISP”). The main processor 611 may further include a neural processing unit (“NPU”) 611-3. The NPU is a processor specialized in processing an artificial intelligence model, and the artificial intelligence model may be generated through machine learning. The artificial intelligence model may include a plurality of artificial neural network layers. The artificial neural network may be one of a deep neural network (“DNN”), a convolutional neural network (“CNN”), a recurrent neural network (“RNN”), a restricted boltzmann machine (“RBM”), a deep belief network (“DBN”), a bidirectional recurrent deep neural network (“BRDNN”), a deep Q-network, or a combination of two or more of the above, but is not limited to the above-described example. In addition to or as an alternative to a hardware structure, the artificial intelligence model may include a software structure. At least two of the above-described processing units and processors may be implemented as a single integrated component (e.g., a single chip) or as separate components (e.g., a plurality of chips).

The auxiliary processor 612 may include a driving controller 612-1. The driving controller 612-1 may include an interface conversion circuit and a timing control circuit. The driving controller 612-1 may receive an image signal from the main processor 611, convert a data format of the image signal to correspond to an interface specification with the display module 640, and output image data. The driving controller 612-1 may output various control signals desired for driving the display module 640. The configuration of the driving controller 612-1 may be similar to that of the driving controller 100 shown in FIG. 2, and thus, detailed descriptions of the driving controller 612-1 are omitted.

The auxiliary processor 612 may further include a data conversion circuit 612-2, a gamma correction circuit 612-3, a rendering circuit 612-4, or the like. The data conversion circuit 612-2 may receive the image data from the driving controller 612-1, compensate for the image data to display an image with a desired luminance based on characteristics of the electronic device 601, user settings, or the like, or convert the image data to reduce power consumption or to compensate for image retention. The gamma correction circuit 612-3 may convert the image data, a gamma reference voltage, or the like so that the image displayed on the electronic device 601 has a desired gamma characteristic. The rendering circuit 612-4 may receive the image data from the driving controller 612-1 and render the image data taking into account a pixel arrangement or the like of the display panel 641 applied to the electronic device 601. At least one of the data conversion circuit 612-2, the gamma correction circuit 612-3, and the rendering circuit 612-4 may be integrated into another component (e.g., the main processor 611 or the driving controller 612-1). At least one of the data conversion circuit 612-2, the gamma correction circuit 612-3, and the rendering circuit 612-4 may be integrated into a source driver 643, which is described later.

The memory 620 may store various data used by at least one component (e.g., the processor 610 or the sensor module 661) of the electronic device 601 and input or output data related to corresponding commands. The memory 620 may include at least one of the volatile memory 621 and the nonvolatile memory 622.

The input module 630 may receive commands or data to be used by a component (e.g., the processor 610, the sensor module 661, or the audio output module 663) of the electronic device 601 from an external source (e.g., the user or the external electronic device 602) of the electronic device 601.

The input module 630 may include a first input module 631 receiving commands or data from the user and a second input module 632 receiving commands or data from the external electronic device 602. The first input module 631 may include a microphone, a mouse, a keyboard, a key (e.g., a button), or a pen (e.g., a passive pen or an active pen). The second input module 632 may support a designated protocol that enables connection to the external electronic device 602 via a wired or wireless connection. In an embodiment, the second input module 632 may include a high definition multimedia interface (“HDMI”), a universal serial bus (“USB”) interface, a secure digital card interface, or an audio interface. The second input module 632 may include a connector capable of physically connecting to the external electronic device 602, e.g., an HDMI connector, a USB connector, a secure digital card connector, or an audio connector (e.g., a headphone connector).

The display module 640 may provide visual information to the user. The display module 640 may include the display panel 641, a scan driver 642, and the source driver 643. The display module 640 may further include a window, a chassis, and a bracket to protect the display panel 641. The display module 640 may further include an emission driver, a voltage generator, or the like. The voltage generator may output various voltages, e.g., the first and second driving voltages ELVDD and ELVSS (refer to FIG. 3A), desired for driving the display panel 641. The configurations of the display panel 641, the scan driver 642, the source driver 643, and the voltage generator may be substantially similar to those of the display panel DP, the scan driver 250, the source driver 200, and the voltage generator 300 shown in FIG. 3A, and thus, detailed descriptions of the display panel 641, the scan driver 642, the source driver 643, and the voltage generator are omitted.

The power module 650 may supply power to components of the electronic device 601. The power module 650 may include a battery that charges a power voltage. The battery may include a non-rechargeable primary cell, a rechargeable secondary cell, or fuel cell. The power module 650 may include a power management integrated circuit (“PMIC”). The PMIC may supply optimized power to each of the above-described modules and modules described later. The power module 650 may include a wireless power transmission/reception member electrically connected to the battery. The wireless power transmission/reception member may include a plurality of antenna radiators of a coil form.

The electronic device 601 may further include the internal module 660 and the external module 670. The internal module 660 may include the sensor module 661, the antenna module 662, and the audio output module 663. The external module 670 may include the camera module 671, a light module 672, and the communication module 673.

The sensor module 661 may sense an input by a body part of the user or an input by a pen of the first input module 631 and may generate an electrical signal or a data value corresponding to the input. The sensor module 661 may include at least one of the fingerprint sensor 661-1, the input sensor 661-2, and a digitizer 661-3.

The fingerprint sensor 661-1 may generate a data value corresponding to a fingerprint of the user. The fingerprint sensor 661-1 may include any one of an optical type fingerprint sensor or a capacitive type fingerprint sensor.

The input sensor 661-2 may generate a data value corresponding to coordinate information of the input by the body part of the user or the input by the pen. The input sensor 661-2 may generate the data value based on the change in capacitance caused by the input. The input sensor 661-2 may sense an input by the passive pen or may transmit/receive data to and from the active pen.

The input sensor 661-2 may measure a biometric signal such as blood pressure, hydration levels, or body fat. In an embodiment, when the user touches a part of their body to a sensor layer or a sensing panel and remains still for a predetermined period, the input sensor 661-2 may sense the biometric signal based on changes in an electric field caused by the body part and output information desired by the user to the display module 640, for example.

The digitizer 661-3 may generate a data value corresponding to coordinate information of the input by the pen. The digitizer 661-3 may generate the data value based on changes in an electromagnetic field caused by the input. The digitizer 661-3 may sense the input by the passive pen or may transmit/receive data to and from the active pen.

At least one of the fingerprint sensor 661-1, the input sensor 661-2, and the digitizer 661-3 may be implemented as a sensor layer formed on the display panel 641 through a continuous process. The fingerprint sensor 661-1, the input sensor 661-2, and the digitizer 661-3 may be disposed above the display panel 641, or any one of the fingerprint sensor 661-1, the input sensor 661-2, and the digitizer 661-3, e.g., the digitizer 661-3 may be disposed below the display panel 641.

At least two of the fingerprint sensor 661-1, the input sensor 661-2, and the digitizer 661-3 may be integrated into a single sensing panel through the same process. When at least two of the fingerprint sensor 661-1, the input sensor 661-2, and the digitizer 661-3 are integrated into one sensing panel, the sensing panel may be disposed between the display panel 641 and the window disposed above the display panel 641. In an embodiment, the sensing panel may be disposed on the window, and a position of the sensing panel should not be particularly limited.

At least one of the fingerprint sensor 661-1, the input sensor 661-2, and the digitizer 661-3 may be embedded in the display panel 641. That is, at least one of the fingerprint sensor 661-1, the input sensor 661-2, and the digitizer 661-3 may be simultaneously formed through a process of forming elements (e.g., a light-emitting element, a transistor, or the like) included in the display panel 641.

In addition, the sensor module 661 may generate an electrical signal or a data value corresponding to an internal state or an external state of the electronic device 601. The sensor module 661 may further include, e.g., a gesture sensor, a gyro sensor, a barometric pressure sensor, a magnetic sensor, an acceleration sensor, a grip sensor, a proximity sensor, a color sensor, an infrared (“IR”) sensor, a biometric sensor, a temperature sensor, a humidity sensor, or an illuminance sensor.

The antenna module 662 may include one or more antennas to transmit a signal or power to an external source or to receive a signal or power from an external source. In an embodiment, the communication module 673 may transmit a signal to an external electronic device or may receive a signal from an external electronic device through an antenna suitable for a communication method. An antenna pattern of the antenna module 662 may be integrated into one component (e.g., the display panel 641) of the display module 640 or the input sensor 661-2.

The audio output module 663 is a device to output an audio signal to an outside of the electronic device 601 and, e.g., may include a speaker used for general purposes such as multimedia playback or voice recording playback and a receiver used exclusively to receive a phone call. In an embodiment, the receiver may be formed integrally with or separately from the speaker. An audio output pattern of the audio output module 663 may be integrated into the display module 640.

The camera module 671 may capture a still image and a video. In an embodiment, the camera module 671 may include one or more lenses, an image sensor, or an image signal processor. The camera module 671 may further include an infrared camera capable of detecting presence or absence of the user, a position of the user, a gaze of the user, or the like.

The light module 672 may provide light. The light module 672 may include a light-emitting diode or a xenon lamp. The light module 672 may operate in conjunction with the camera module 671 or may operate independently.

The communication module 673 may support the establishment of a wired or wireless communication channel between the electronic device 601 and the external electronic device 602 and the communication through the established communication channel. The communication module 673 may include one or both of a wireless communication module, such as a cellular communication module, a short-range wireless communication module, or a global navigation satellite system (“GNSS”) communication module, and a wired communication module, such as a local area network (“LAN”) communication module or a power line communication module. The communication module 673 may communicate with the external electronic device 602 through a short-range communication network such as Bluetooth, WiFi direct, or infrared data association (“IrDA”), or a long-range communication network such as a cellular network, the Internet, or a computer network (e.g., LAN or WAN). The various types of communication modules 673 described above may be implemented as a single chip or as separate chips.

The input module 630, the sensor module 661, the camera module 671, or the like may be used in conjunction with the processor 610 to control an operation of the display module 640.

The processor 610 may output commands or data to the display module 640, the audio output module 663, the camera module 671, or the light module 672 based on input data received from the input module 630. In an embodiment, the processor 610 may generate image data in response to the input data applied through the mouse, the active pen, or the like and output the image data to the display module 640, or may generate command data in response to the input data and output the command data to the camera module 671 or the light module 672, for example. When no input data is received from the input module 630 for a predetermined period of time, the processor 610 may switch the operation mode of the electronic device 601 to a low power mode or a sleep mode to reduce power consumed in the electronic device 601.

The processor 610 may output commands or data to the display module 640, the audio output module 663, the camera module 671, or the light module 672 based on sensing data received from the sensor module 661. In an embodiment, the processor 610 may compare authentication data applied by the fingerprint sensor 661-1 with authentication data stored in the memory 620 and then execute an application according to a comparison result, for example. The processor 610 may execute the command based on sensing data sensed by the input sensor 661-2 or the digitizer 661-3 or may output image data corresponding to the sensing data to the display module 640. When the sensor module 661 includes a temperature sensor, the processor 610 may receive temperature data measured by the sensor module 661 and further perform luminance correction or the like on the image data based on the temperature data.

The processor 610 may receive detected data regarding the presence or absence of the user, the position of the user, the gaze of the user, or the like, from the camera module 671. The processor 610 may further perform luminance correction or the like on the image data based on the detected data. In an embodiment, when the processor 610 determines the presence or absence of the user through an input from the camera module 671, the processor 610 may output image data whose luminance is corrected through the data conversion circuit 612-2 or the gamma correction circuit 612-3 to the display module 640, for example.

Among the above-described components, some components may be connected to each other through a communication method for peripheral devices, e.g., a bus, general purpose input/output (“GPIO”), a serial peripheral interface (“SPI”), a mobile industry processor interface (“MIPI”), or an ultra-path interconnect (“UPI”) link to exchange a signal (e.g., commands or data) with each other. The processor 610 may communicate with the display module 640 through a mutually agreed interface, e.g., any one of the above-described communication methods, and the communication method should not be limited to the above-described communication methods.

The electronic device 601 according to the disclosure may be applied to various types of devices. The electronic device 601 may include, e.g., at least one of a portable communication device (e.g., a smartphone), a computer device, a portable multimedia device, a portable medical device, a camera, a wearable device, and a home appliance device. The electronic device 601 according to the disclosure should not be limited to the above-described devices.

Although the embodiments of the disclosure have been described, it is understood that the disclosure should not be limited to these embodiments but various changes and modifications may be made by one ordinary skilled in the art within the spirit and scope of the disclosure as hereinafter claimed. Therefore, the disclosed subject matter should not be limited to any single embodiment described herein, and the scope of the inventive concept shall be determined according to the attached claims.

What is claimed is:

1. A display device comprising:
a display panel which displays an image in a first mode or a second mode, the display panel comprising:
a pixel;
a source driver which applies a data voltage to the pixel; and
a scan driver which applies a scan signal to the pixel, the scan driver comprising:
a plurality of stages,
wherein each of the plurality of stages receives k clock signals, the k is an integer greater than or equal to 2, the k clock signals are sequentially activated in the first mode so that the scan signal is applied to the pixel, at least two clock signals among the k clock signals are activated simultaneously in the second mode so that the scan signal is applied to the pixel, and at least one clock signal among the k clock signals is activated in different periods in a first frame and a second frame following the first frame in the second mode.

2. The display device of claim 1, wherein the k is greater than or equal to 4, the k clock signals are grouped into k/2 clock groups, and clock signals included in a same clock group among the k clock signals are activated simultaneously.

3. The display device of claim 2, wherein at least one clock group among the k/2 clock groups comprises p clock signals in the first frame, the at least one clock group comprises q clock signals in the second frame, the q is an integer different from the p, and each of the p and the q is smaller than the k.

4. The display device of claim 3, wherein, when a first clock signal among the p clock signals is activated, remaining p-1 clock signals are activated in synchronization with an activation time point of the first clock signal among the p clock signals in the first frame, and when a first clock signal among the q clock signals is activated, remaining q-1 clock signals are activated in synchronization with an activation time point of the first clock signal among the q clock signals in the second frame.

5. The display device of claim 4, wherein each of the plurality of stages is connected to k scan lines, p scan signals, which are activated at an activation time point of the p clock signals, are output to p scan lines among the k scan lines, respectively, in the first frame, q scan signals, which are activated at an activation time point of the q clock signals, are output to q scan lines among the k scan lines, respectively, in the second frame, scan signals are activated simultaneously in response to clock signals activated simultaneously.

6. The display device of claim 5, wherein the pixel is provided in plural,
a first scan signal is applied to pixels arranged in a first pixel row, and a second scan signal is applied to pixels arranged in a second pixel row.

7. The display device of claim 6, wherein a first row data voltage applied to the pixels arranged in the first pixel row are applied to the pixels arranged in the first and the second pixel row when the first and second scan signals are activated simultaneously.

8. The display device of claim 6, wherein a second row data voltage applied to the pixels arranged in the second pixel row are applied to the pixels arranged in the first and the second pixel row when the first and second scan signals are activated simultaneously.

9. The display device of claim 3, wherein the at least one clock group comprises g clock signals in a third frame following the second frame, the g is an integer different from the p and the q, the at least one clock group comprises h clock signals in a fourth frame following the third frame, h is an integer different from the p and the g, and each of the g and the h is smaller than the k.

10. The display device of claim 2, wherein the k is 6, and the clock group comprises a first clock group, a second clock group, and a third clock group.

11. The display device of claim 10, wherein each of the first clock group, the second clock group, and the third clock group comprises two clock signals in the first frame, the first clock group comprises three clock signals in the second frame, the second clock group comprises one clock signal in the second frame, and the third clock group comprises two clock signals in the second frame.

12. The display device of claim 10, wherein each of the first clock group, the second clock group, and the third clock group comprises two clock signals in the first frame, the first clock group comprises two clock signals in the second frame, the second clock group comprises three clock signals in the second frame, and the third clock group comprises one clock signal in the second frame.

13. The display device of claim 10, wherein each of the first clock group, the second clock group, and the third clock group comprises two clock signals in the first frame, the first clock group comprises one clock signal in the second frame, the second clock group comprises two clock signals in the second frame, and the third clock group comprises three clock signals in the second frame.

14. A display device comprising:
a display panel which displays an image in a first mode or a second mode, the display panel comprising:
pixels;
data lines; and
scan lines;
a source driver which applies a data voltage to the data lines; and
a scan driver which applies a scan signal to the scan lines,
wherein the scan signal is sequentially applied to the scan lines in the first mode, the scan signal is applied simultaneously to at least two scan lines among the scan lines in the second mode, a first row data voltage corresponding to the pixels connected to a first scan line of the at least two scan lines is applied to the data lines in a first frame, and a second row data voltage corresponding to the pixels connected to a second scan line of the at least two scan lines is applied to the data lines in a second frame following the first frame.

15. The display device of claim 14, wherein the scan driver comprises a plurality of stages, each of the plurality of stages receives k clock signals, the k is an integer greater than or equal to 2, the k clock signals are sequentially activated in the first mode, and at least two clock signals among the k clock signals are activated simultaneously in the second mode.

16. The display device of claim 15, wherein the k is greater than or equal to 4, the k clock signals are grouped into k/2 clock groups, and clock signals included in a same clock group among the k clock signals are activated simultaneously.

17. The display device of claim 16, wherein at least one clock group among the k/2 clock groups comprises p clock signals in the first frame and the second frame, and the p is an integer smaller than the k.

18. The display device of claim 17, wherein, when a first clock signal among the p clock signals is activated, remaining p-1 clock signals are activated in synchronization with an activation time point of the first clock signal among the p clock signals in the first frame and the second frame.

19. The display device of claim 18, further comprising a first intermediate frame between the first frame and the second frame and a second intermediate frame following the second frame, wherein the at least one clock group comprises q clock signals in the first intermediate frame, the q is an integer different from the p, the at least one clock group comprises h, clock signals in the second intermediate frame, the h is an integer different from the q, and each of the q and the h is smaller than the k.

20. An electronic device comprising:
a display panel which displays an image in a first mode or a second mode, the display panel comprising:
a pixel;
a source driver which applies a data voltage to the pixel;
a scan driver which applies a scan signal to the pixel, the scan driver comprising:
a plurality of stages and;
a driving controller which receives an image signal and a control signal and controlling a drive of the scan driver and the source driver; and
a main processor which applies the image signal and the control signal to the driving controller,
wherein each of the plurality of stages receives k clock signals, the k is an integer greater than or equal to 2, the k clock signals are sequentially activated in the first mode so that the scan signal is applied to the pixel, at least two clock signals among the k clock signals are activated simultaneously in the second mode so that the scan signal is applied to the pixel, and at least one clock signal among the k clock signals is activated in different periods in a first frame and a second frame following the first frame in the second mode.
